(19) United States
(12) Patent Application Publication
(10) Pub. No.: US 2016/0040832 A1
(43) Pub. Date: Feb. 11, 2016

(54) LED ILLUMINATION MODULE

(71) Applicant: ROHM CO., LTD., Kyoto (JP)

(72) Inventors: Sachio SAKAGAMI, Kyoto-shi (JP); Yoshifumi FUJIMOTO, Kyoto-shi (JP); Hideharu OSAWA, Kyoto-shi (JP); Tomoharu HORIO, Kyoto-shi (JP)

(21) Appl. No.: 14/816,564

(22) Filed: Aug. 3, 2015

(30) Foreign Application Priority Data
Aug. 8, 2014 (JP) 2014-162380
Mar. 2, 2015 (JP) 2015-040416
Jul. 22, 2015 (JP) 2015-144845

(51) Int. Cl. F21K 99/00

(52) U.S. Cl. CPC F21K 9/50; F21Y 2101/02

(57) ABSTRACT

An LED illumination module includes: an LED light emission unit that has at least one LED chip; and a covering that allows light from the LED light emission unit to pass through. The covering has an inner surface that is located on the LED light emission unit's side and an outer surface opposite to the inner surface. The covering has at least one of: an inner recessed surface that is formed in the inner surface so as to be recessed in a direction away from the LED light emission unit; and an outer recessed surface that is formed in the outer surface so as to be recessed in a direction toward the LED light emission unit.

### BACKGROUND OF THE INVENTION

1. Field of the Invention

The present invention relates to an LED illumination module.

2. Description of Related Art

Various types of interior lights, such as those for illuminating an entire room and those for illuminating a part of a room, have been proposed. Downlights are a kind of light fixture that are to be embedded in a ceiling, and are used mainly for illuminating a desired part of a floor surface. In recent years, LED light fixtures in which an LED chip is used as a light source for a downlight have been developed. JP-A-2012-22994 discloses an LED light fixture for use as a downlight. This LED light fixture includes an LED illumination module. The LED illumination module includes a plurality of LED chips, a casing that holds these LED chips, a covering that allows light from the plurality of LED chips to pass through, and a base. The covering has a circular shape in plan view, and allows light from the plurality of LED chips to pass through and diffuse. The front surface of the covering is a circular flat surface. The base is of the GX53 type defined in the IEC standards, for example, and allows the LED illumination module to be attached to or detached from a power feeding unit that is disposed at the bottom of an opening part in the ceiling. An LED light fixture that serves as a downlight embedded in the ceiling is configured by attaching the LED illumination module to the power feeding unit.

Also, JP-A-2013-171650 discloses a light fixture that is to be attached to the ceiling or a wall in a house, and that employs an LED chip as a light source. This kind of light fixture includes an LED chip, an external covering that allows light from this LED chip to pass through, a casing that holds the LED chip, and so on. By employing an LED chip as a light source, it is possible to achieve a reduction in power consumption and extend the time period up until replacement.

### SUMMARY OF THE INVENTION

The present invention has been proposed under the above-described circumstances, and an object thereof is to provide an LED illumination module that can realize more preferable light emission than is conventionally possible.

The present invention provides an LED illumination module including: an LED light emission unit having at least one LED chip; and a covering that allows light from the LED light emission unit to pass through, wherein the covering has an inner surface that is located on the LED light emission unit's side and an outer surface that is located on an opposite side to the inner surface, and the covering has at least one of: an inner recessed surface that is formed in the inner surface so as to be recessed in a direction away from the LED light emission unit; and an outer recessed surface that is formed in the outer surface so as to be recessed in a direction toward the LED light emission unit.

Preferably, the inner recessed surface is a smooth mirror-finished surface.

Preferably, the inner recessed surface faces the LED light emission unit.

Preferably, the inner recessed surface has a circular shape in plan view.

Preferably, the inner surface has an inner ring-shaped surface that surrounds the inner recessed surface.

Preferably, the inner ring-shaped surface is a smooth mirror-finished surface.

Preferably, the inner ring-shaped surface is a flat surface.

Preferably, the inner ring-shaped surface has a circular ring shape in plan view.

Preferably, the inner surface has a circular shape in plan view.

Preferably, the outer surface is an entirely uneven surface.

Preferably, the outer surface as a whole has a shape that bulges in a direction away from the LED light emission unit.

Preferably, a radius of curvature of the outer surface is greater than a radius of curvature of the inner recessed surface.

Preferably, the outer surface is a flat surface.

Preferably, the outer recessed surface overlaps the inner recessed surface in plan view.

Preferably, the outer recessed surface is a smooth mirror-finished surface.

Preferably, a center point of the outer recessed surface and a center point of the inner recessed surface coincide with each other in plan view.

Preferably, a radius of curvature of the outer recessed surface is greater than a radius of curvature of the inner recessed surface.

Preferably, the outer recessed surface is greater than the inner recessed surface in plan view.

Preferably, the outer recessed surface has a cone shape.

Preferably, the outer surface has an outer ring-shaped surface that surrounds the outer recessed surface.

Preferably, the outer ring-shaped surface is an uneven surface.

Preferably, the outer ring-shaped surface is a smooth surface.

Preferably, the outer ring-shaped surface has a shape that bulges in a direction away from the LED light emission unit.

Preferably, the outer ring-shaped surface is a flat surface.

Preferably, the outer surface has a circular shape in plan view.

Preferably, the inner recessed surface is smaller than a light emission region of the LED light emission unit in plan view.

Preferably, the inner recessed surface is greater than a light emission region of the LED light emission unit in plan view.

Preferably, the LED light emission unit has the LED chip that is provided in a plurality, the plurality of LED chips being arranged discretely in plan view, and the covering has the inner recessed surface that is provided in a plurality, the plurality of inner recessed surfaces respectively overlapping the plurality of LED chips in plan view.

Other features and advantages of the present invention will become apparent from the detailed description given below with reference to the accompanying drawings.

### BRIEF DESCRIPTION OF THE DRAWINGS

FIG. 1 is a plan view showing an LED illumination module based on a first embodiment of the present invention.

FIG. 2 is a side view showing the LED illumination module in FIG. 1.

FIG. 3 is a bottom view showing the LED illumination module in FIG. 1.

FIG. 4 is a cross-sectional view along a line IV-IV in FIG. 1.

FIG. 5 is an enlarged cross-sectional view showing a main portion of the LED illumination module in FIG. 1.

FIG. 6 is a plan view showing an LED light emission unit of the LED illumination module in FIG. 1.

FIG. 7 is a cross-sectional view along a line VII-VII in FIG. 6.

FIG. 8 is an enlarged plan view showing a main portion of the LED light emission unit of the LED illumination module in FIG. 1.

FIG. 9 is a perspective view showing a process by which the LED illumination module in FIG. 1 is attached to a ceiling.

FIG. 10 is a perspective view showing the LED illumination module in FIG. 1 in the state of being attached to the ceiling.

FIG. 11 is a cross-sectional view showing an LED illumination module based on a second embodiment of the present invention.

FIG. 12 is an enlarged cross-sectional view showing a main portion of the LED illumination module in FIG. 11.

FIG. 13 is a cross-sectional view showing an LED illumination module based on a third embodiment of the present invention.

FIG. 14 is an enlarged cross-sectional view showing a main portion of the LED illumination module in FIG. 13.

FIG. 15 is a cross-sectional view showing an LED illumination module based on a fourth embodiment of the present invention.

FIG. 16 is an enlarged cross-sectional view showing a main portion of the LED illumination module in FIG. 15.

FIG. 17 is a cross-sectional view showing an LED illumination module based on a fifth embodiment of the present invention.

FIG. 18 is a cross-sectional view showing an LED illumination module based on a sixth embodiment of the present invention.

FIG. 19 is a cross-sectional view showing an LED illumination module based on a seventh embodiment of the present invention.

FIG. 20 is a cross-sectional view showing an LED illumination module based on an eighth embodiment of the present invention.

FIG. 21 is a front view showing an example of an LED illumination device according to the present invention.

FIG. 22 is a plan view showing the LED illumination device in FIG. 21.

FIG. 23 is a cross-sectional view along a line XXIII-XXIII in FIG. 22.

FIG. 24 is an enlarged cross-sectional view showing a main portion of the LED illumination device in FIG. 21.

FIG. 25 is a perspective view showing an LED module used in the LED illumination device in FIG. 21.

FIG. 26 is a perspective view showing the LED module used in the LED illumination device in FIG. 21.

FIG. 27 is a plan view showing the LED module used in the LED illumination device in FIG. 21.

FIG. 28 is a front view showing the LED module used in the LED illumination device in FIG. 21.

FIG. 29 is a side view showing the LED module used in the LED illumination device in FIG. 21.

FIG. 30 is a cross-sectional view along a line XXX-XXX in FIG. 27.

FIG. 31 is a cross-sectional view along a line XXXI-XXXI in FIG. 27.

FIG. 32 is a cross-sectional view showing an LED light emission unit used in the LED illumination device in FIG. 21.

FIG. 33 is a front view showing another example of an LED illumination device according to the present invention.

FIG. 34 is a plan view showing the LED illumination device in FIG. 33.

FIG. 35 is a cross-sectional view along a line XXXV-XXXV in FIG. 34.

FIG. 36 is an enlarged cross-sectional view showing a main portion of the LED illumination device in FIG. 33.

FIG. 37 is a plan view showing yet another example of an LED illumination device according to the present invention.

FIG. 38 is a cross-sectional view along a line XXXVIII-XXXVIII in FIG. 37.

FIG. 39 is a bottom view showing a modification of a covering for an LED module.

FIG. 40 is a cross-sectional view along a line XL-XL in FIG. 39.

FIG. 41 is a front view showing yet another example of an LED illumination device according to the present invention.

FIG. 42 is a side view showing the LED illumination device in FIG. 41.

FIG. 43 is a cross-sectional view along a line XLIII-XLIII in FIG. 41.

FIG. 44 is a cross-sectional view showing another embodiment of an LED module.

### DESCRIPTION OF THE PREFERRED EMBODIMENTS

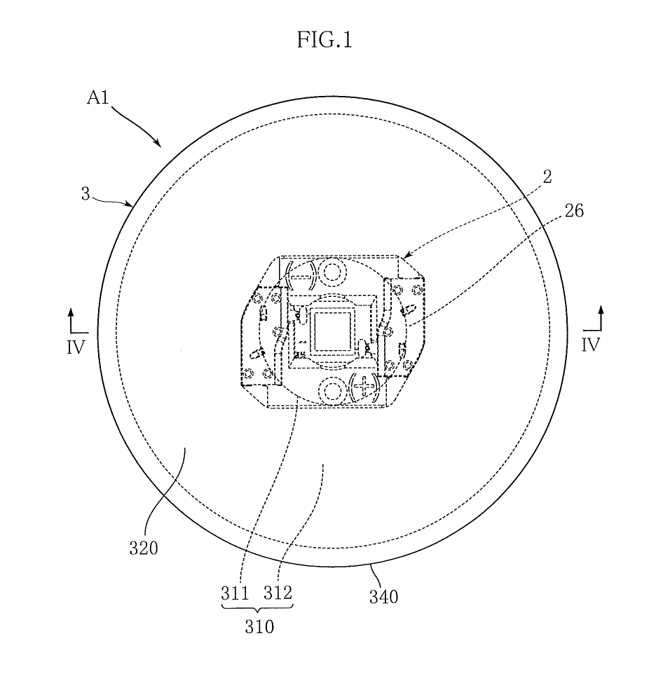

FIG. 1 to FIG. 5 show an LED illumination module based on a first embodiment of the present invention. An LED illumination module A1 according to the present embodiment includes a casing 1, an LED light emission unit 2, a covering 3, and a power supply unit 5. The LED illumination module A1 is a module that constitutes a so-called downlight, and is intended to be used as a reading light, which is attached to a power feeding unit disposed on the ceiling side of a vehicle, particularly a railway carriage for example. In the present embodiment, the LED illumination module A1 has a substantially circular cylinder shape with a relatively short length in the axial direction.

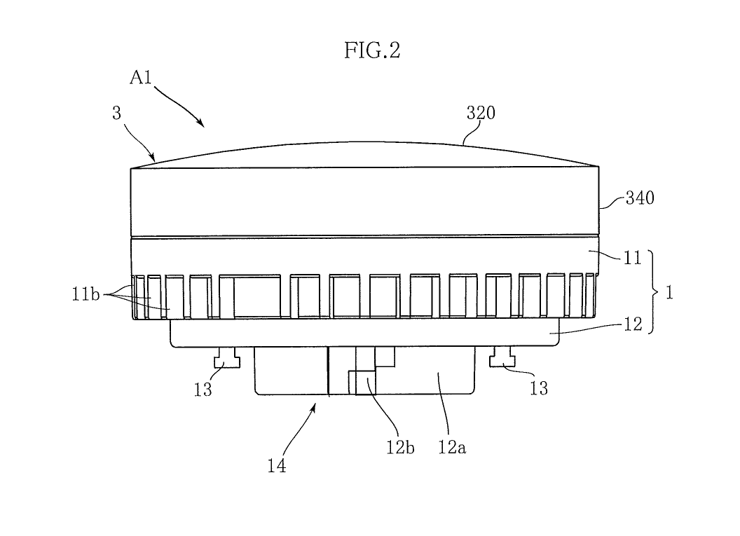

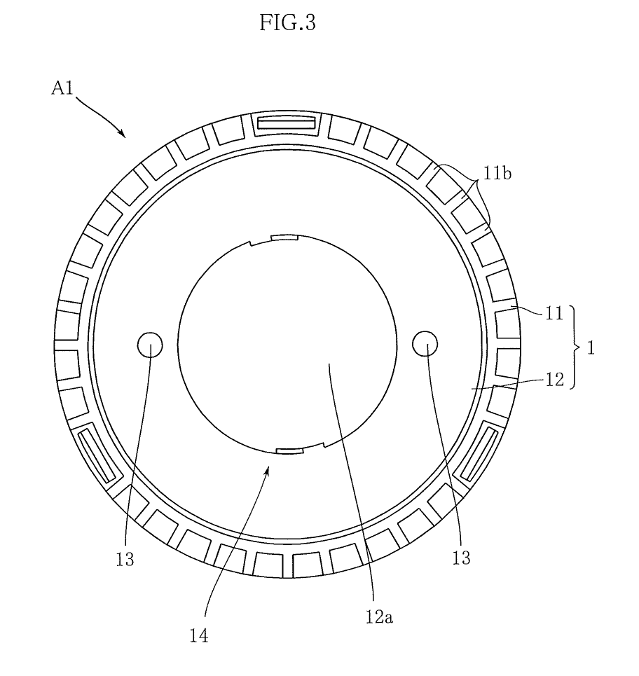

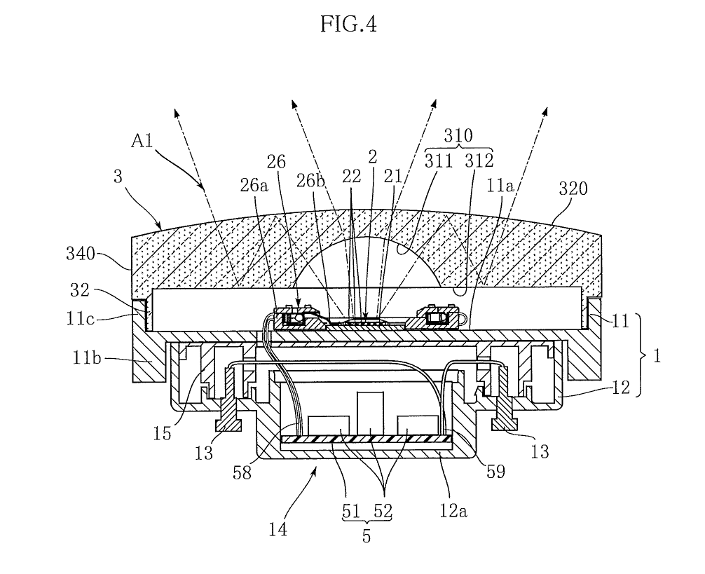

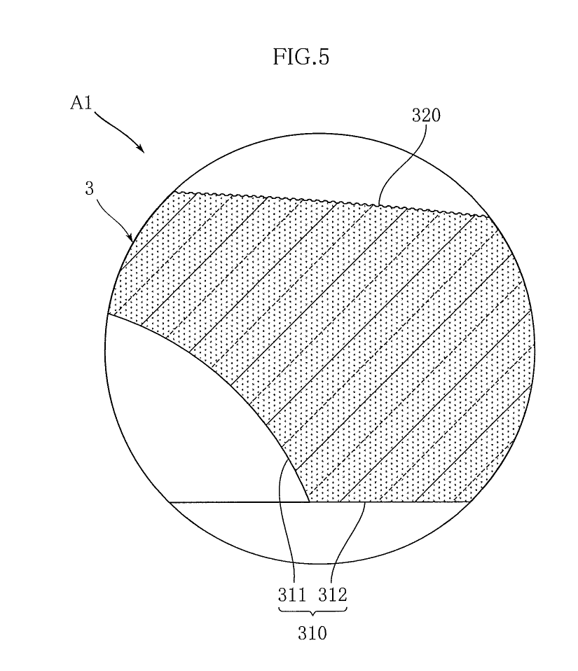

FIG. 1 is a plan view showing the LED illumination module A1. FIG. 2 is a side view showing the LED illumination module A1. FIG. 3 is a bottom view showing the LED illumination module A1. FIG. 4 is a cross-sectional view along a line IV-IV in FIG. 1, and FIG. 5 is an enlarged cross-sectional view showing a main portion.

The casing 1 houses or holds the LED light emission unit 2, the covering 3, and the power supply unit 5. In the present embodiment, the casing 1 is made up of a heat dissipation member 11, an insulation member 12, and an intermediate bracket 15. In the present embodiment, the casing 1 has a circular shape in plan view.

The heat dissipation member 11 is a member intended to dissipate heat from the LED light emission unit 2, and is made of metal such as aluminum, for example. The heat dissipation member 11 has a mounting surface 11a, a plurality of fins 11b, and an engaging part 11c. The mounting surface 11a faces in an emission direction, which is the direction in which light is emitted from the LED light emission unit 2 (upward in FIG. 4), and is substantially a flat surface having a circular shape. The plurality of fins 11b are for facilitating dissipation of heat from the LED light emission unit 2, and are disposed along the entire length of a peripheral portion of the heat dissipation member 11. The fins 11b are parallel to the axial direction and the radial direction of the LED illumination module A1. The engaging part 11c is a circular ring-shaped part that surrounds the mounting surface 11a. The engaging part 11c is used for attaching the covering 3.

The insulation member 12 is attached to the opposite side of the heat dissipation member 11 to the emission direction, and, in the present embodiment, has a circular shape in plan view. The insulation member 12 is made of insulating material, and, in the present embodiment, is made of polybutylene terephthalate (PBT) resin, for example. The insulation member 12 has a protruding part 12a. The protruding part 12a is a part that has a circular cylinder shape and protrudes in the opposite direction to the emission direction. As shown in FIG. 2, a groove part 12b is formed in the protruding part 12a. The groove part 12b has a portion that extends in the axial direction and a portion that is continuous with it and extends in the circumferential direction. Also, the insulation member 12 is provided with two pins 13. The two pins 13 are located on the opposite sides of the protruding part 12a in the radial direction, and protrude in the opposite direction to the emission direction. This protruding part 12a and the two pins 13 constitute a base 14. The base 14 is, as described below, used for attaching the LED illumination module A1 to a power feeding unit disposed on the ceiling, for example, and is of the GX53 type defined in the IEC standards, for example.

The intermediate bracket 15 is provided between the heat dissipation member 11 and the insulation member 12. The intermediate bracket 15 is made of insulating material, and, in the present embodiment, is made of polybutylene terephthalate (PBT) resin, for example. The intermediate bracket 15 has the function of fixing and holding the two pins 13 and the power supply unit 5, and of holding wiring that connects the two pins 13, the LED light emission unit 2, and the power supply unit 5.

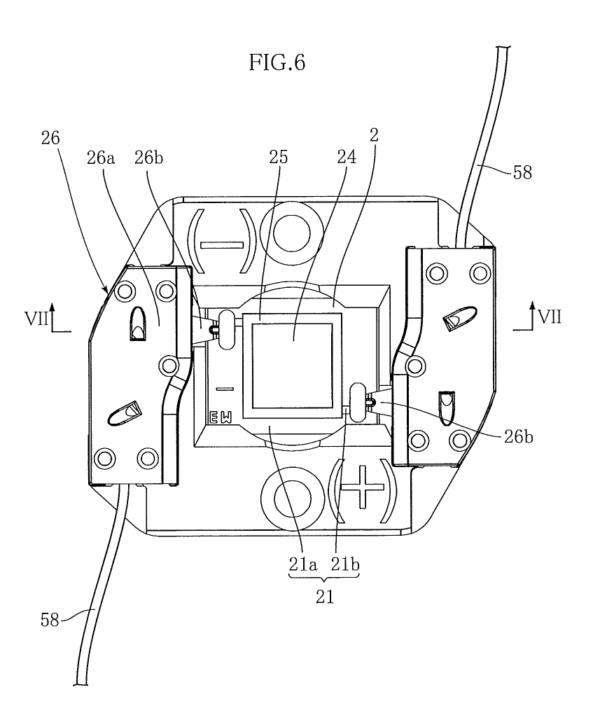

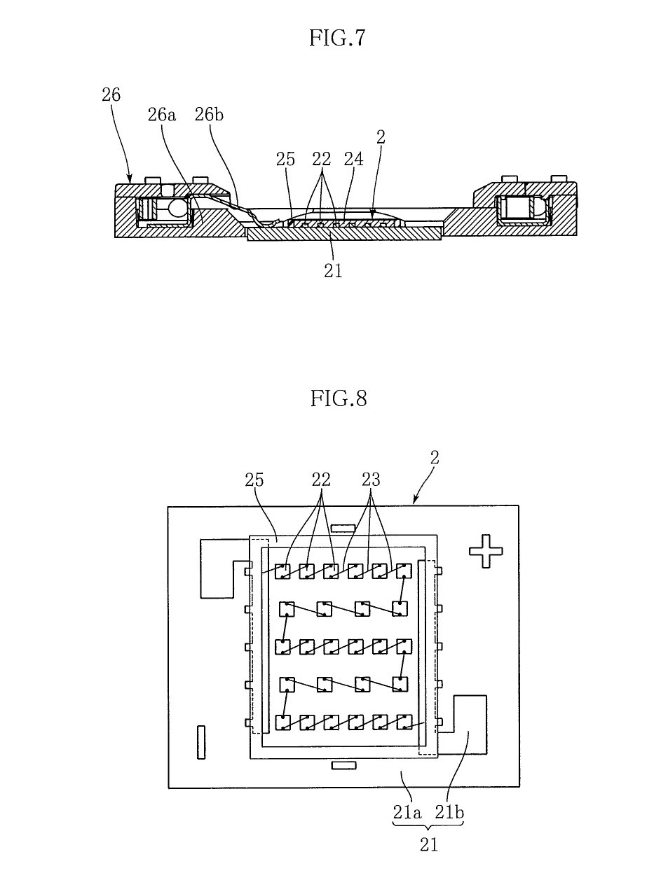

The LED light emission unit 2 is a unit that serves as a light source of the LED illumination module A1. As shown in FIG. 6 to FIG. 8, the LED light emission unit 2 includes an LED substrate 21, a plurality of LED chips 22, a sealing resin 24, a dam part 25, and a holder 26. FIG. 6 is a plan view of the LED light emission unit 2. FIG. 7 is a cross-sectional view along a line VII-VII in FIG. 6. FIG. 8 is a plan view of the LED light emission unit 2 from which the sealing resin 24 and the holder 26 are omitted.

As shown in FIG. 8, the LED substrate 21 has a rectangular shape in plan view, for example, and the plurality of LED chips 22 are mounted thereon. Although the configuration of the LED substrate 21 is not particularly limited, the LED substrate 21 in the present embodiment has a base member 21a and a wiring pattern 21b. The dimensions of the LED substrate 21 in plan view are approximately 12 mm×15 mm, for example.

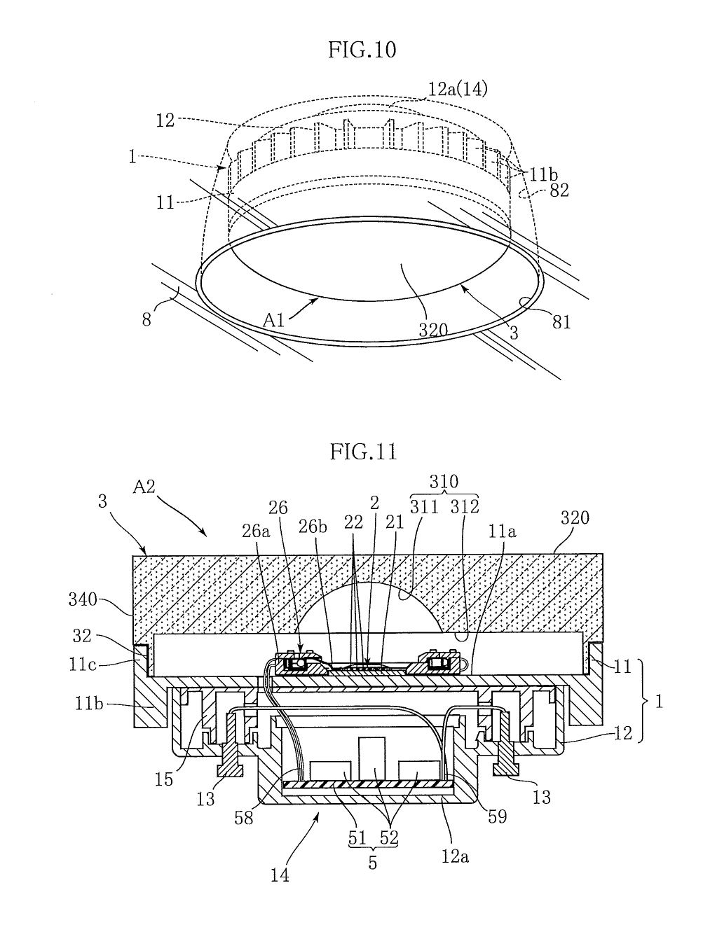

The base member 21a is made of insulating material, and is made of glass epoxy resin or ceramic with enhanced thermal conductivity. The wiring pattern 21b is mounted with the plurality of LED chips 22, and constitutes conduction paths to these LED chips 22. The wiring pattern 21b is made of a metal-plated layer, and is made of Cu, Ni, Au, or Ag, for example. In the present embodiment, the wiring pattern 21b has a bonding pad for mounting twenty-six LED chips 22 thereon, and two connection pads for electrical connection with the holder 26. The two connection pads are, in FIG. 10, parts that have a rectangular shape and are arranged to be separate in a diagonal direction of the LED substrate 21 with the plurality of LED chips 22 between them.

The plurality of LED chips 22 are light emission elements of the LED light emission unit 2. The LED chips 22 have a semiconductor layer made of GaN for example, and emit blue light for example. In the present embodiment, twenty-six LED chips 22 are mounted on the LED substrate 21. These LED chips 22 are arranged substantially in the shape of a matrix. The LED chips 22 are LED chips of the so-called two-wire type. In the present embodiment, adjacent LED chips 22 are connected directly to each other with a wire 23. Also, in the present embodiment, all of the LED chips 22 are connected with each other in series. These LED chips 22 are connected in series between the two connection pads of the wiring pattern 21b. The array pitch of the plurality of LED chips 22 is 1.0 mm to 1.7 mm, for example.

The dam part 25 is formed on the LED substrate 21, and surrounds the plurality of LED chips 22. In the present embodiment, the dam part 25 has a rectangular ring shape in plan view, and is made of white epoxy resin, for example. The height of the dam part 25 is greater than the height of the LED chips 22.

The sealing resin 24 covers the plurality of LED chips 22, and fills the region that is surrounded by the dam part 25. The sealing resin 24 is made of, for example, transparent resin such as silicone resin or epoxy resin, into which fluorescent material is mixed. This fluorescent material emits yellow light due to excitation by blue light from the LED chips 22. Alternatively, a mixture of a fluorescent material that emits red light and a fluorescent material that emits green light, due to excitation by blue light from the LED chips 22, may be used. With this configuration, the LED light emission unit 2 emits light of a white color such as a warm white color or a daylight color.

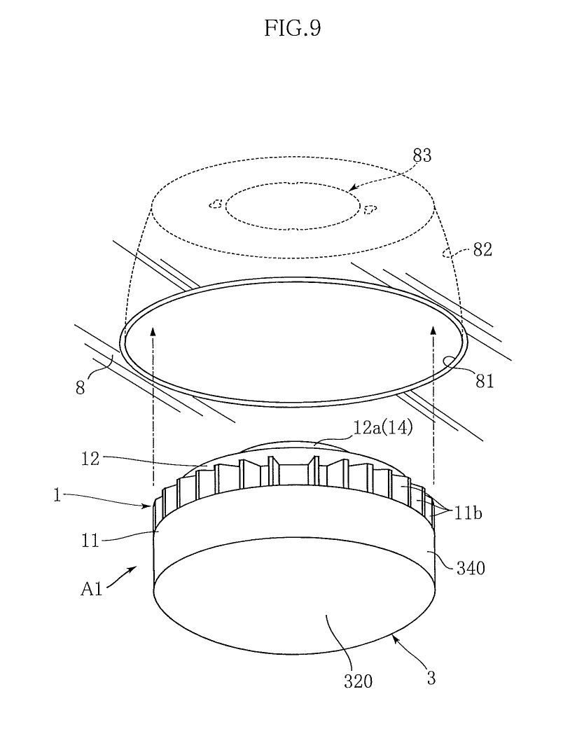

The holder 26 is for fixing and holding the LED substrate 21 on the mounting surface 11a of the heat dissipation member 11. The holder 26 has a body 26a and two holding electrodes 26b. The body 26a is made of insulating resin for example, and as shown in FIG. 8 and FIG. 9, its dimensions are greater than those of the LED substrate 21 in plan view. Also, an opening is provided in a central portion of the body 26a such that the sealing resin 24 covering the plurality of LED chips 22 is exposed therefrom. The two holding electrodes 26b are respectively in contact with the two connection pads of the wiring pattern 21b of the LED substrate 21. The two holding electrodes 26b are electrically connected with two external connection terminals provided for the holder 26, which are not depicted. These external connection terminals are electrically connected to the power supply unit 5. The holder 26 is attached to the heat dissipation member 11 with a screw or by fitting.

The covering 3 is attached to the casing 1 so as to be located in the emission direction. The covering 3 allows light from the LED light emission unit 2 to pass through. Also, in the present embodiment, the covering 3 allows light from the LED light emission unit 2 to pass through and diffuse. The material of the covering 3 is, for example, light-transmissive resin, or glass into which diffusing material is mixed. Due to such a configuration, the covering 3 has a milky white color for example.

The covering 3, in the present embodiment, has a circular shape in plan view, and has an inner surface 310, an outer surface 320, a side surface 340, and an engaging part 32.

The inner surface 310 is located on the LED light emission unit 2 side, and directly faces the mounting surface 11a of the heat dissipation member 11 of the casing 1. The inner surface 310 has an inner recessed surface 311 and an inner ring-shaped surface 312. In the present embodiment, the inner surface 310 has a circular shape in plan view.

The inner surface 310 is recessed in the direction away from the LED light emission unit 2 (upward in FIG. 4). In the present embodiment, the inner surface 310 has a circular shape in plan view. Also, the inner recessed surface 311 directly faces the LED light emission unit 2. Furthermore, the dimensions of the inner recessed surface 311 are greater than the dimensions of the sealing resin 24 in plan view, which constitutes the light emission region of the LED light emission unit 2, and the inner recessed surface 311 encompasses the sealing resin 24 in plan view. The inner recessed surface 311 is a smooth mirror-finished surface as shown in FIG. 5. In plan view, the inner recessed surface 311 in the present embodiment is greater than the sealing resin 24, which is the light emission region of the LED light emission unit 2, and encompasses the light emission region.

The inner ring-shaped surface 312 surrounds the inner recessed surface 311, and, in the present embodiment, has a circular shape in plan view. The inner ring-shaped surface 312 is a flat surface that is parallel to the mounting surface 11a as shown in FIG. 5. The inner ring-shaped surface 312 is a smooth mirror-finished surface as with the inner recessed surface 311.

The outer surface 320 is located on the opposite side to the inner surface 310, and has a circular shape in plan view. In the present embodiment, the outer surface 320 has a shape that bulges out in the direction away from the LED light emission unit 2 (upward in FIG. 4). The radius of curvature of the outer surface 320 is greater than the radius of curvature of the inner recessed surface 311. The outer surface 320 is an entirely uneven surface as shown in FIG. 5. This uneven surface can bring about the effect of appropriately diffusing the light emitted from the outer surface 320, and is referred to as a crimped surface.

The side surface 340 extends along the direction in which the inner surface 310 and the outer surface 320 are separated from each other, and is a curved surface having a circular cross section. The engaging part 32 is provided at the peripheral edge of the covering 3, and has the function of attaching the covering 3 to the casing 1 by engaging with the engaging part 11c of the heat dissipation member 11 of the casing 1.

The power supply unit 5 is, for example, for converting commercial 100 V AC power to DC power that is suited to light the plurality of LED chips 22 of the LED light emission unit 2. The power supply unit 5 is housed within the protruding part 12a of the insulation member 12.

The power supply unit 5 in the present embodiment is made of a power supply substrate 51 and a plurality of electronic parts 52.

The power supply substrate 51 serves as a foundation for the power supply unit 5, and supports the plurality of electronic parts 52. The power supply substrate 51 also has conduction paths for electrically connecting the plurality of electronic parts 52 with each other as needed.

The plurality of electronic parts 52 are elements that constitute a power supply circuit for realizing the functions of the power supply unit 5. Although the types and the specifications of the plurality of electronic parts are not particularly limited, their representative examples include a transformer, a capacitor, a resistor, a diode, and so on.

An LED cable 58 and a power supply cable 59 are connected to the power supply unit 5. The LED cable 58 is for supplying power from the power supply unit 5 to the LED light emission unit 2, and is connected to the power supply unit 5 and the LED light emission unit 2. The power supply cable 59 is for conducting power received from the outside to the power supply unit 5, and is connected to the power supply unit 5 and the pins 13 of the casing 1.

FIG. 9 shows a process by which the LED illumination module A1 is attached to a ceiling 8. An attachment hole 81 is provided in the ceiling 8, and a reflector 82 is installed in the attachment hole 81. A power feeding unit 83 is provided at the bottom of the attachment hole 81. The power feeding unit 83 is configured such that a base of the GX53 type defined in the IEC standards can be attached thereto. The LED illumination module A1 is lifted up from below the attachment hole 81, and is positioned at the bottom of the attachment hole 81. Next, the LED illumination module A1 is rotated relative to the power feeding unit 83. As a result, the two pins 13 of the base 14 engage with the power feeding unit 83. Also, the groove part 12b of the protruding part 12a of the insulation member 12 engages with the power feeding unit 83. Due to this relative rotation, the LED illumination module A1 having a circular shape in plan view is rotated about an axis that extends in the axial direction. By attaching the LED illumination module A1 to the power feeding unit 83, as shown in FIG. 10, the LED illumination module A1 is brought into the state of being able to be supplied with power from the power feeding unit 83, and being surrounded by the reflector 82. Thus, a so-called downlight is configured. Upon being powered on with a switch, which is not shown in the drawings, the LED light emission unit 2 of the LED illumination module A1 starts lighting. Light from the LED light emission unit 2 passes through the covering 3, and a portion of the light illuminates a floor surface directly, and another portion of the light is reflected by the reflector 82 and then illuminates a floor surface and a wall surface.

Next, a description is given of the effect of the LED illumination module A1.

Since the LED light emission unit 2 has the LED chips 22, which are point light sources, the light that travels toward the front side of the LED light emission unit 2 has a relatively high intensity. In the present embodiment, as shown in FIG. 4, light from the LED light emission unit 2 travels outward with respect to the center point in plan view by being deflected by the inner recessed surface 311. Therefore, it is possible to avoid illuminating only part of the front side of the LED illumination module A1 in the emission direction with an inappropriately high illuminance. Thus, with the LED illumination module A1, it is possible to realize preferable light emission. One of the uses of the LED illumination module A1 configured as a downlight is as a reading light in a vehicle such as a railway carriage. Reading lights need to illuminate a book in a passenger's hand with a required illuminance. Also, in a situation where a certain illuminance is attained, if any part of the book is extremely bright, the passenger feels the glare on the book. Since LED chips are point light sources, there is the concern of illuminating a part of the book with inappropriately bright light. The LED illumination module A1, when used as a reading light, suppresses the glare and contributes to the passenger enjoying reading without a sense of discomfort.

Since the inner recessed surface 311 is a mirror-finished surface, the above-described effect of spreading the light from the LED light emission unit 2, in other words, the effect of the inner recessed surface 311 serving as a lens, can be properly achieved.

Since the inner recessed surface 311 directly faces the LED light emission unit 2, a relatively high intensity portion of the light from the LED light emission unit 2 can be appropriately diffused by the inner recessed surface 311.

The inner ring-shaped surface 312, which surrounds the inner recessed surface 311, is provided, and this inner ring-shaped surface 312 is a mirror-finished surface. With this configuration, when light enters into the covering 3 and then travels toward the LED light emission unit 2, this light can be totally reflected by the inner ring-shaped surface 312. Therefore, it is possible to prevent a decrease in the amount of light from the LED illumination module A1.

Since the outer surface 320 is an uneven surface, which is a so-called crimped surface, light travelling inside the covering 3 is diffused by the outer surface 320. As a result, the glare can be suppressed more effectively. Also, the covering 3 made of material that allows light from the LED light emission unit 2 to pass through and diffuse is suited to prevent the glare.

In the LED light emission unit 2, due to the configuration in which the plurality of LED chips 22 are covered with the sealing resin 24, the LED light emission unit 2 externally appears as if surface emission was being performed. With this configuration, it is possible to avoid non-uniform brightness of objects illuminated by the LED illumination module A1 or of the LED illumination module A1 itself resulting from the plurality of point light sources. Due to the relationship in which, in plan view, the inner recessed surface 311 is greater than the sealing resin 24 and the inner recessed surface 311 encompasses the sealing resin 24, high-intensity light travelling from the sealing resin 24 toward the front side in the emission direction can be appropriately spread by the inner recessed surface 311.

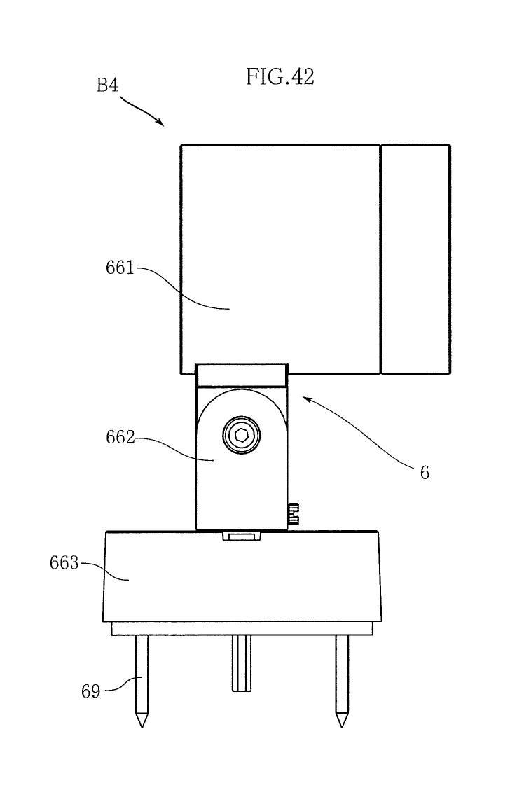

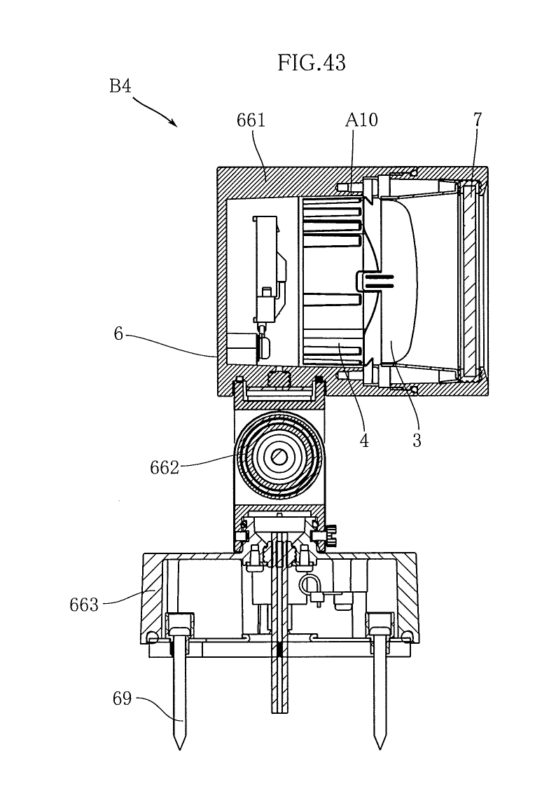

FIG. 11 to FIG. 44 show other embodiments of the present invention. Note that in these figures, the same reference signs are given to elements that are the same as or similar to the elements in the above-described embodiment.

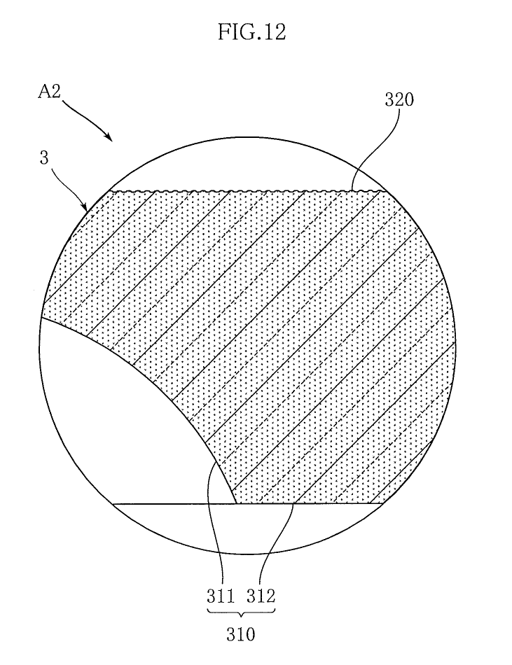

FIG. 11 and FIG. 12 show an LED illumination module based on a second embodiment of the present invention. FIG. 11 is a cross-sectional view showing an LED illumination module A2, and FIG. 12 is an enlarged cross-sectional view of a main portion. The LED illumination module A2 according to the present embodiment is different from the above-described embodiment in the configuration of the outer surface 320.

In the present embodiment, the outer surface 320 is a flat surface that is parallel to the mounting surface 11a and the inner ring-shaped surface 312. In the present embodiment as well, the outer surface 320 is an entirely uneven surface, which is a so-called crimped surface.

With such an embodiment as well, it is possible to realize preferable light emission, and it is possible to prevent the glare.

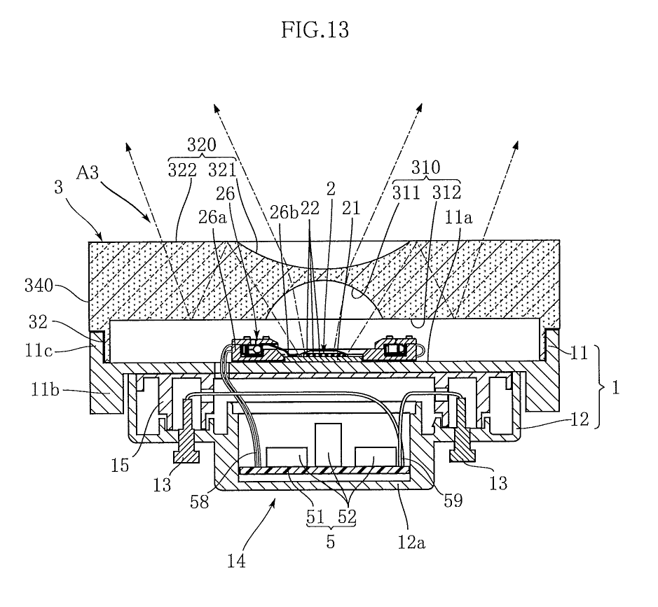

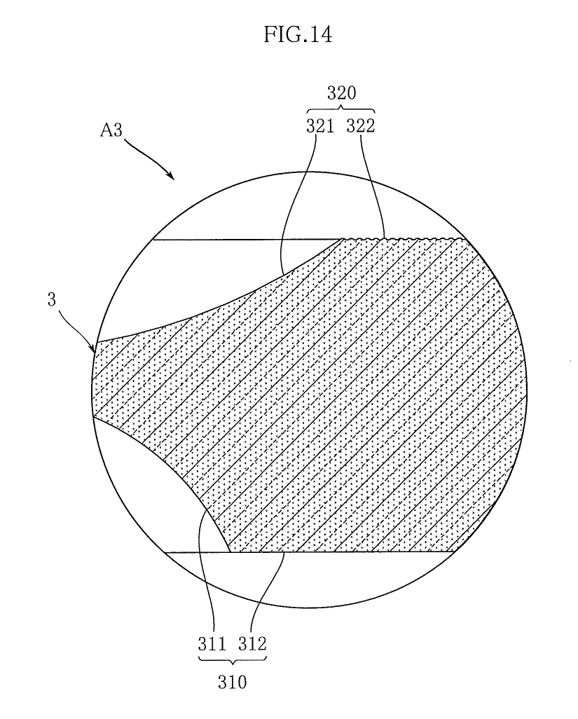

FIG. 13 and FIG. 14 show an LED illumination module based on a third embodiment of the present invention. FIG. 13 is a cross-sectional view showing an LED illumination module A3, and FIG. 14 is an enlarged cross-sectional view of a main portion. The LED illumination module A3 according to the present embodiment is different from the above-described embodiments in the configuration of the outer surface 320.

In the present embodiment, the outer surface 320 has an outer recessed surface 321 and an outer ring-shaped surface 322.

The outer recessed surface 321 overlaps the inner recessed surface 311 in plan view. Also, the outer recessed surface 321 is recessed toward the LED light emission unit 2 (downward in FIG. 13), and has a circular shape in plan view. The lens center point of the outer recessed surface 321 and the lens center point of the inner recessed surface 311 coincide with each other in plan view. The radius of curvature of the outer recessed surface 321 is greater than the radius of curvature of the inner recessed surface 311. Also, the outer recessed surface 321 is greater than the inner recessed surface 311 in plan view. As shown in FIG. 14, the outer recessed surface 321 is a smooth mirror-finished surface as with the inner recessed surface 311.

The outer ring-shaped surface 322 surrounds the outer recessed surface 321, and, in the present embodiment, has a circular ring shape. The outer ring-shaped surface 322 is a flat surface that is parallel to the mounting surface 11a and the inner ring-shaped surface 312. As shown in FIG. 14, the outer ring-shaped surface 322 is an uneven surface, which is a so-called crimped surface.

With such an embodiment as well, it is possible to realize preferable light emission, and it is possible to prevent the glare. Also, since the outer surface 320 has the outer recessed surface 321, as shown in FIG. 13, light that has traveled through the inside of the covering 3 can be spread further outward by the outer recessed surface 321. Therefore, due to the synergy of the inner recessed surface 311 and the outer recessed surface 321, it is possible to further prevent the glare. The outer recessed surface 321 being a mirror-finished surface is advantageous in that such a lens effect is properly achieved. Since the outer recessed surface 321 is a crimped surface, light that has traveled to near the outer recessed surface 321 can be emitted with the impression of being relatively gentle light.

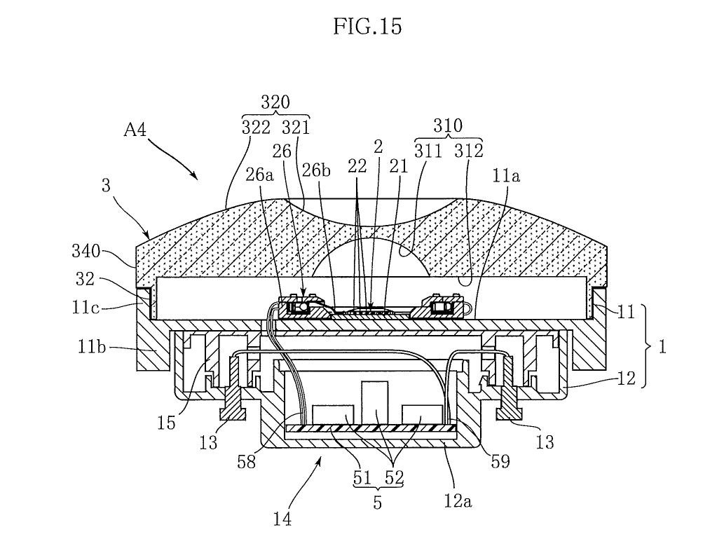

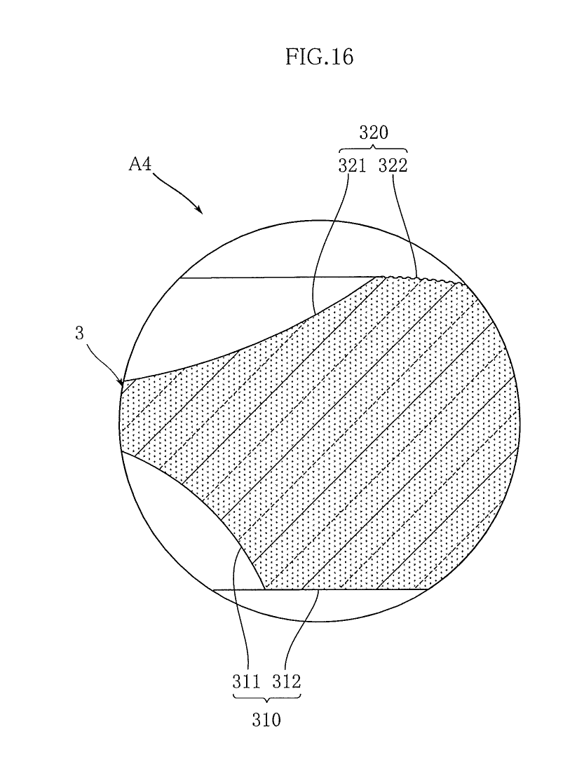

FIG. 15 and FIG. 16 show an LED illumination module based on a fourth embodiment of the present invention. FIG. 15 is a cross-sectional view showing an LED illumination module A4, and FIG. 16 is an enlarged cross-sectional view of a main portion. The LED illumination module A4 according to the present embodiment is different from the above-described embodiments in the configuration of the outer surface 320.

The outer surface 320 has the outer recessed surface 321 and the outer ring-shaped surface 322.

The outer recessed surface 321 overlaps the inner recessed surface 311 in plan view. Also, the outer recessed surface 321 is recessed toward the LED light emission unit 2 (downward in FIG. 15), and has a circular shape in plan view. The lens center point of the outer recessed surface 321 and the lens center point of the inner recessed surface 311 coincide with each other in plan view. The radius of curvature of the outer recessed surface 321 is greater than the radius of curvature of the inner recessed surface 311. Also, the outer recessed surface 321 is greater than the inner recessed surface 311 in plan view. As shown in FIG. 16, the outer recessed surface 321 is a smooth mirror-finished surface as with the inner recessed surface 311.

The outer ring-shaped surface 322 surrounds the outer recessed surface 321, and, in the present embodiment, has a circular ring shape. The outer ring-shaped surface 322 has a shape that bulges out in the direction away from the LED light emission unit 2 (upward in FIG. 15). As shown in FIG. 16, the outer ring-shaped surface 322 is an uneven surface, which is a so-called crimped surface.

With such an embodiment as well, it is possible to realize preferable light emission, and it is possible to prevent the glare.

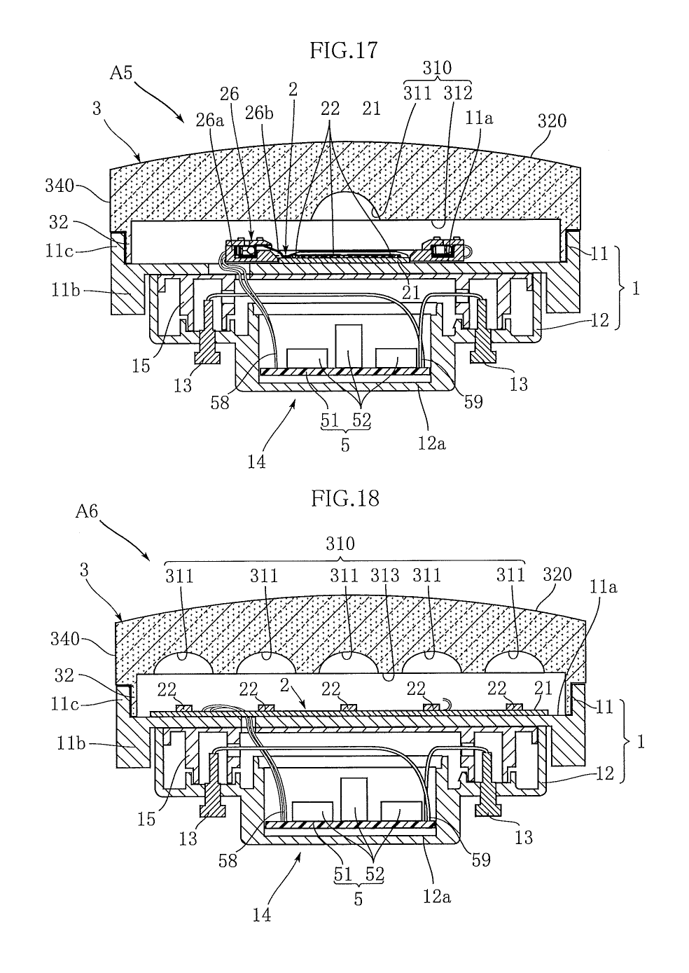

FIG. 17 shows an LED illumination module based on a fifth embodiment of the present invention. FIG. 17 is a cross-sectional view showing an LED illumination module A5. In the present embodiment, in plan view, the inner recessed surface 311 is smaller than the sealing resin 24, which is the light emission region of the LED light emission unit 2, and is encompassed by the light emission region.

With such an embodiment as well, it is possible to realize preferable light emission, and it is possible to prevent the glare.

FIG. 18 shows an LED illumination module based on a sixth embodiment of the present invention. FIG. 18 is a cross-sectional view showing an LED illumination module A6. In the present embodiment, the LED light emission unit 2 is made up of the LED substrate 21 and the plurality of LED chips 22. The plurality of LED chips 22 are arranged discretely in plan view. The inner surface 310 of the covering 3 has a plurality of inner recessed surfaces 311 and an inner surface 313. The plurality of inner recessed surfaces 311 are arranged so as to respectively overlap the plurality of LED chips 22 in plan view, and are recessed from the inner surface 313. In the present embodiment, the inner surface 313 is a flat surface. It is preferable that in plan view, the center point of each inner recessed surface 311 coincides with the center point of the corresponding LED chips 22.

With such an embodiment as well, it is possible to realize preferable light emission, and it is possible to prevent the glare.

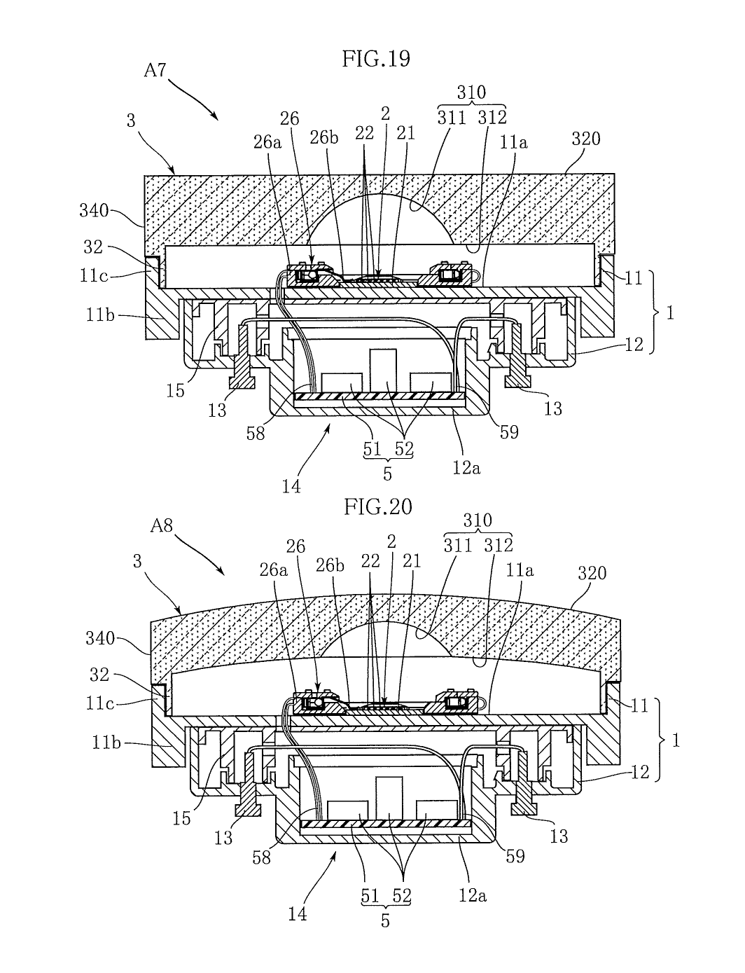

FIG. 19 shows an LED illumination module based on a seventh embodiment of the present invention. FIG. 19 is a cross-sectional view showing an LED illumination module A7. In the present embodiment, both the inner surface 310 and the outer surface 320 are flat surfaces. The inner recessed surface 311, which is the same as in the above-described LED illumination module A1, is formed in the inner surface 310.

With such an embodiment as well, it is possible to realize preferable light emission, and it is possible to prevent the glare.

FIG. 20 shows an LED illumination module based on an eighth embodiment of the present invention. FIG. 20 is a cross-sectional view showing an LED illumination module A8. In the present embodiment, the inner ring-shaped surface 312 is a curved surface that is moderately recessed in the direction away from the LED light emission unit 2.

With such an embodiment as well, it is possible to realize preferable light emission, and it is possible to prevent the glare.

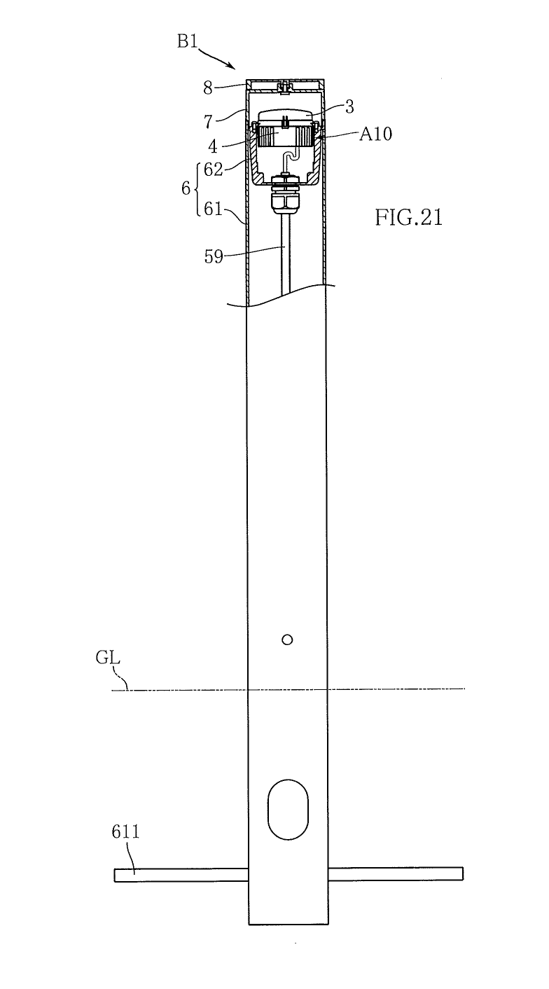

FIG. 21 to FIG. 24 show an example of an LED illumination device according to the present invention. An LED illumination device B1 in the present embodiment includes an LED module A10, a device casing 6, an external covering 7, and a light-shielding covering 79. The LED illumination device B1 is used as, for example, a so-called garden light, which is installed in the upright position in a garden.

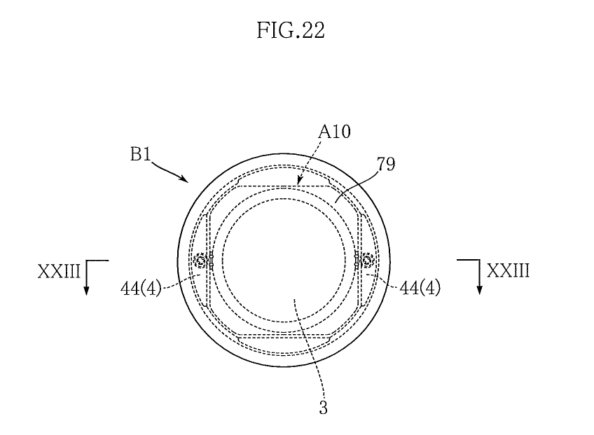

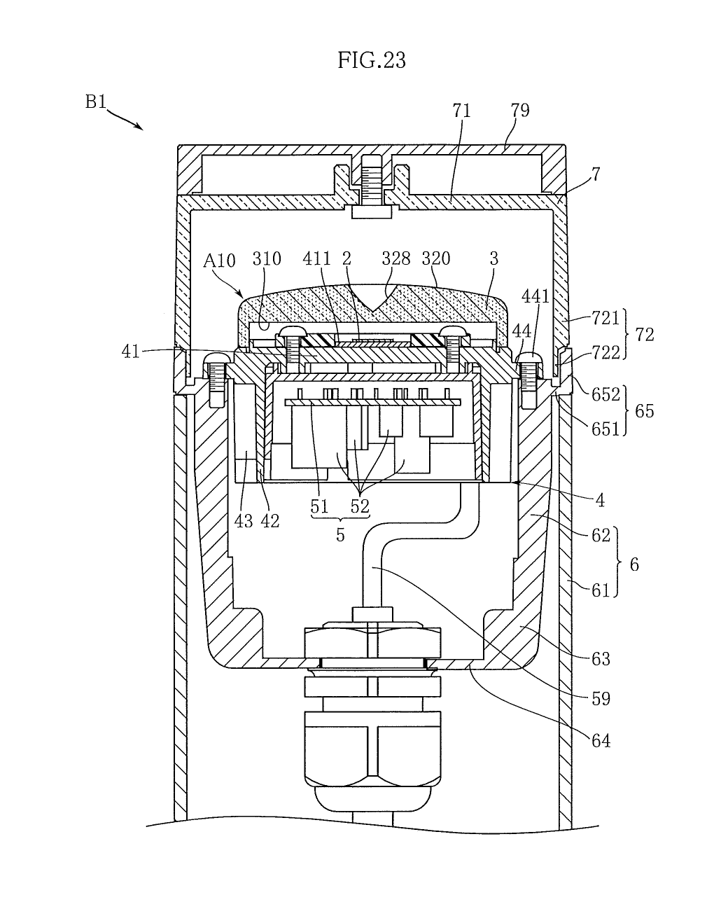

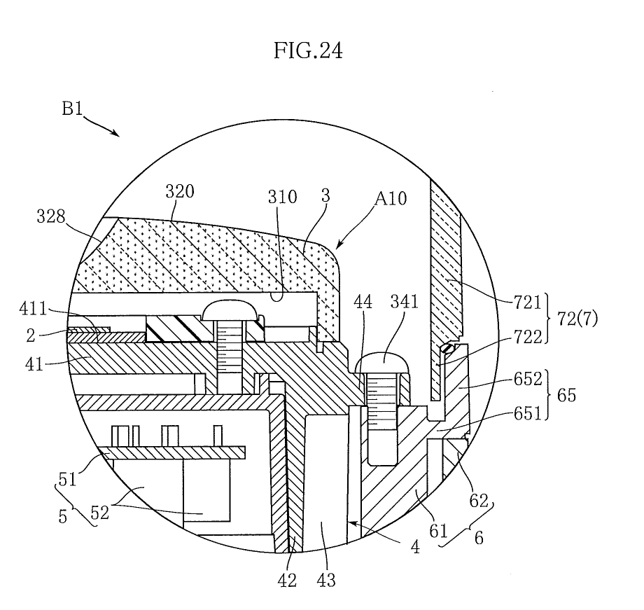

FIG. 21 is a plan view showing the LED illumination device B1. FIG. 22 is a plan view showing the LED illumination device B1. FIG. 23 is a cross-sectional view along a line XXIII-XXIII in FIG. 22. FIG. 24 is an enlarged cross-sectional view showing a main portion of the LED illumination device in FIG. 21. Note that the emission direction of the below-described LED light emission unit 2 provided in the LED module A10 corresponds to the vertical direction in FIG. 21, FIG. 23, and in FIG. 24, and the upward direction in the drawings is defined as forward in the emission direction, and the downward direction in the drawings is defined as backward in the emission direction. The emission direction of the LED light emission unit 2 corresponds to the direction along the center of light emitted from the LED light emission unit 2. Note that the luminance of the LED light emission unit 2 is not necessarily at its maximum value in the emission direction.

The device casing 6 supports the LED module A10. The device casing 6 includes an outer cylinder part 61 and a cup-shaped part 62.

The outer cylinder part 61 has a cylindrical shape whose axial direction coincides with the emission direction (the vertical direction in FIG. 21). In the present embodiment, the outer cylinder part 61 has a circular cylinder shape. A lower portion of the outer cylinder part 61 in the drawing is buried in the ground such that a line GL shown in the drawing coincides with the surface of the ground. A burial support rod 611 is provided near a lower end of the outer cylinder part 61 in the drawing. The burial support rod 611 protrudes in the radial direction, which is orthogonal to the axial direction of the outer cylinder part 61. The burial support rod 611 is for stabilizing the outer cylinder part 61 in an upright position. The outer cylinder part 61 is made of, for example, metal such as aluminum.

A large portion of the cup-shaped part 62 is housed within the outer cylinder part 61. The cup-shaped part 62 houses a portion of the LED module A10. The cup-shaped part 62 has an inner cylinder part 63, a bottom part 64 and a ring-shaped flange part 65. The inner cylinder part 63 is a cylindrical part whose axial direction coincides with the emission direction. The bottom part 64 closes a backward portion of the inner cylinder part 63 in the emission direction. The power supply cable 59 to be connected to the LED module A10 is inserted in the bottom part 64. Note that the outer cylinder part 61 and the cup-shaped part 62 can be coupled to each other by various methods, such as fastening with a bolt not shown in the drawings, or bonding. The inner cylinder part 63 of the cup-shaped part 62 has a greater wall thickness than the outer cylinder part 61. The cup-shaped part 62 is made of, for example, metal such as aluminum.

The ring-shaped flange part 65 extends outward in the radial direction from a forward portion of the inner cylinder part 63 in the emission direction. The ring-shaped flange part 65 is located forward in the emission direction relative to the forward end of the outer cylinder part 61 in the emission direction. Furthermore, in the present embodiment, the ring-shaped flange part 65 is in direct contact with the forward end of the outer cylinder part 61 in the emission direction.

The ring-shaped flange part 65 has a ring-shaped disc part 651 and a short cylindrical part 652. The ring-shaped disc part 651 is connected to the inner cylinder part 63, and extends outward in the radial direction. The ring-shaped disc part 651 has a circular ring shape in a view in the emission direction (a view in the axial direction). The ring-shaped disc part 651 is located slightly backward in the emission direction from the forward end of the inner cylinder part 63 in the emission direction. The short cylindrical part 652 is connected to the peripheral edge of the ring-shaped disc part 651 and stands along the emission direction. In the present embodiment, the ring-shaped disc part 651 is connected to the backward end of the short cylindrical part 652 in the emission direction.

As shown in FIG. 23 and FIG. 24, the ring-shaped disc part 651 is in direct contact with the forward end of the outer cylinder part 61 in the emission direction. Also, between the outer surface of the external covering 7 and the forward end of the outer cylinder part 61 in the emission direction, the ring-shaped disc part 651 extends outward in the radial direction so as to be exposed.

The external covering 7 covers the LED module A10 and the device casing 6 from the forward side in the emission direction, and allows light from the LED module A10 to pass through. The external covering 7 allows light from the LED module A10 to pass through and diffuse, and is made of semitransparent milky white material, for example. The external covering 7 is made of resin or glass.

In the present embodiment, the external covering 7 corresponds to the outer cylinder part 61 of the device casing 6, which has a substantially circular cylinder shape, and accordingly the external covering 7 has a similar shape, which is substantially a circular cylinder shape. The external covering 7 has a top panel part 71 and a cylindrical part 72. The cylindrical part 72 is a cylindrical part whose axial direction coincides with the emission direction. The top panel part 71 closes a forward portion of the cylindrical part 72 in the emission direction. The cylindrical part 72 has a thick-wall cylindrical part 721 and a thin-wall cylindrical part 722. The thick-wall cylindrical part 721 constitutes a large portion of the cylindrical part 72 on the forward side in the emission direction, and has a relatively large wall thickness. The thin-wall cylindrical part 722 is formed to be located backward in the emission direction with respect to the thick-wall cylindrical part 721, and has a relatively small wall thickness. The thin-wall cylindrical part 722 is located inward from the short cylindrical part 652 of the ring-shaped flange part 65 in the radial direction. The external covering 7 is attached to the device casing 6 by various means, such as threading, jointing, or fastening.

The light-shielding covering 79 is attached to the forward end of the external covering 7 in the emission direction, and covers the external covering 7 from the forward side in the emission direction. The light-shielding covering 79 in the present embodiment has a circular shape in plan view (a view in the axial direction), and the diameter thereof is substantially the same as the diameter of the device casing 6. The light-shielding covering 79 is made of opaque material, and blocks light from the LED module A10.

The LED module A10 includes the LED light emission unit 2, a heat dissipation member 4, the covering 3, and the power supply unit 5. As shown in FIG. 23, the LED module A10 is housed within the device casing 6 and the external covering 7. In plan view, the center point of the device casing 6 and the external covering 7 substantially coincide with the center point of the LED module A10.

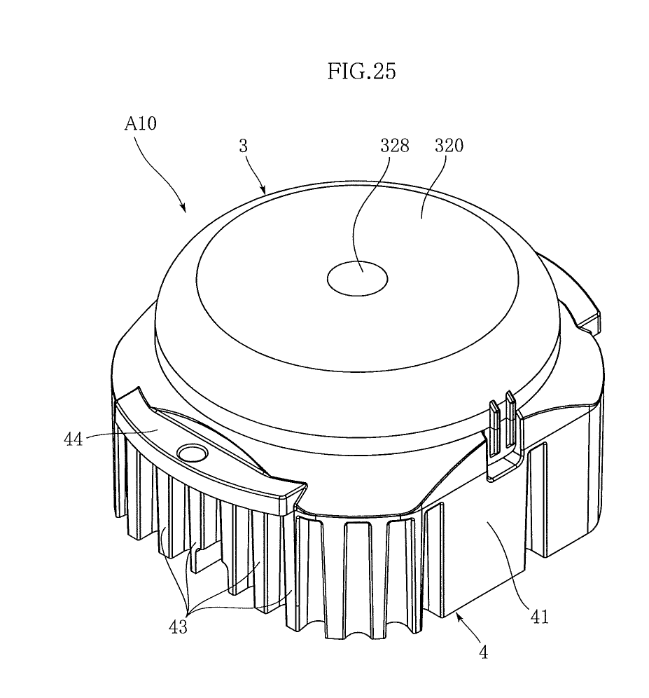

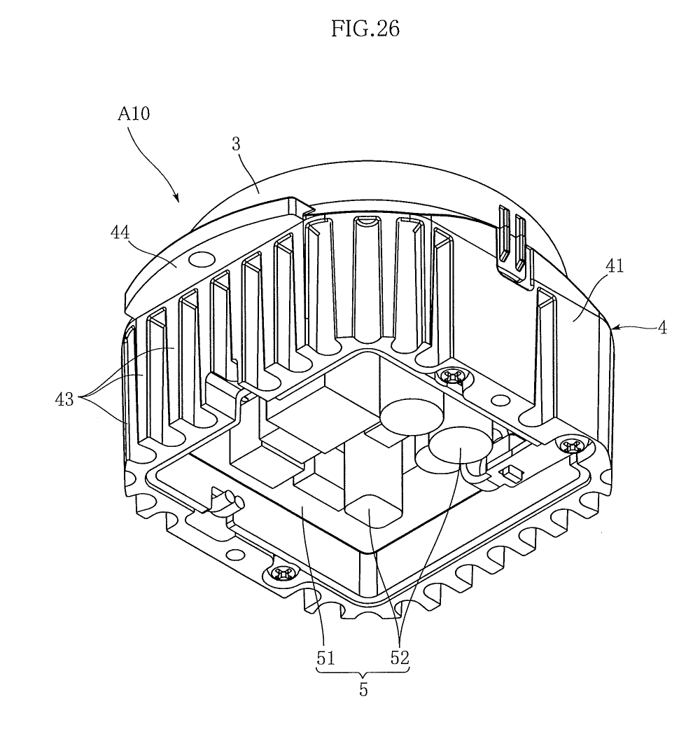

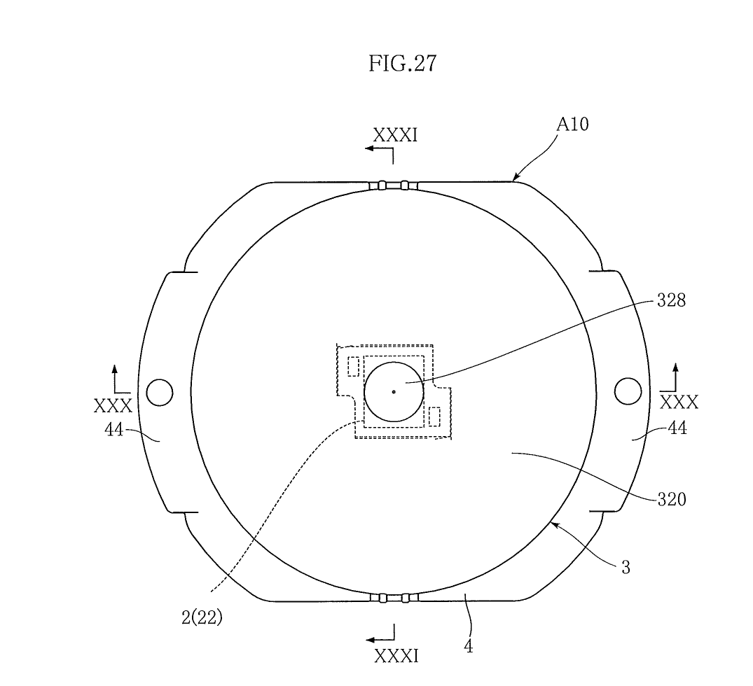

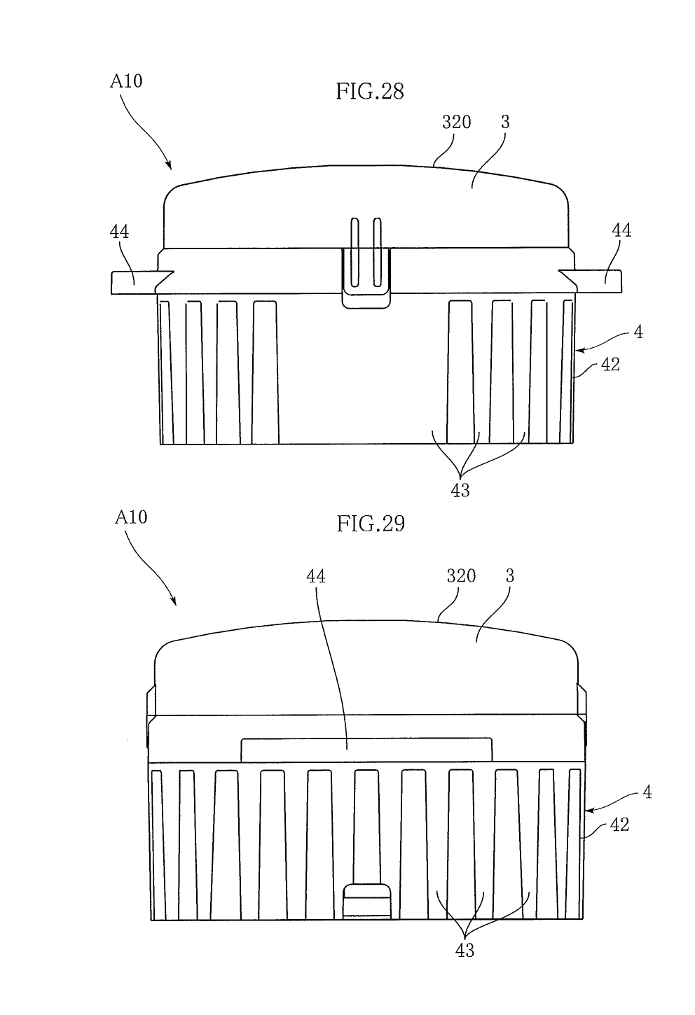

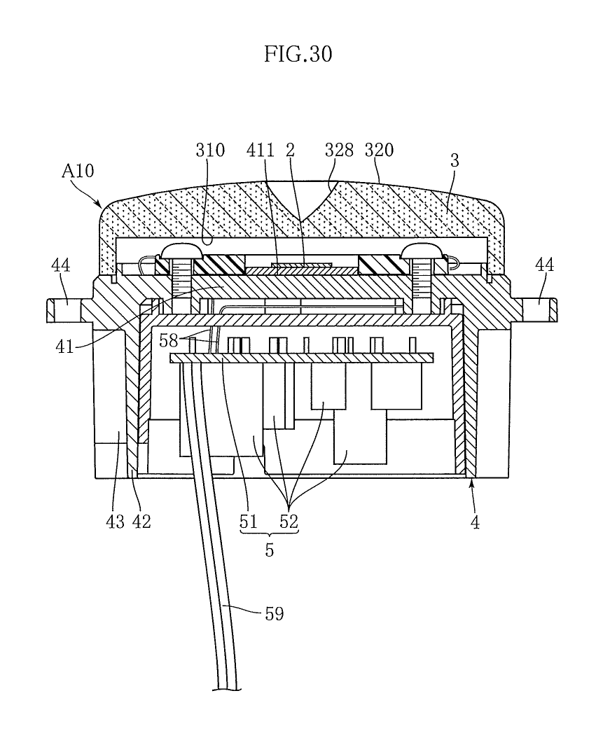

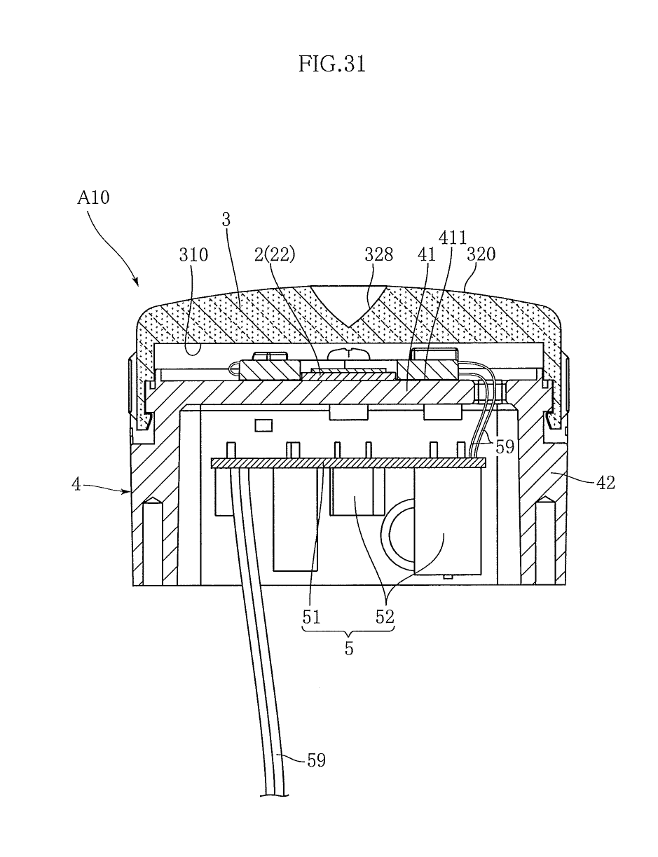

FIG. 25 and FIG. 26 are perspective views showing the LED module A10. FIG. 27 is a plan view showing the LED module A10. FIG. 28 is a front view showing the LED module A10. FIG. 29 is a side view showing the LED module A10. FIG. 30 is a cross-sectional view along a line XXX-XXX in FIG. 27. FIG. 31 is a cross-sectional view along a line XXXI-XXXI in FIG. 27.

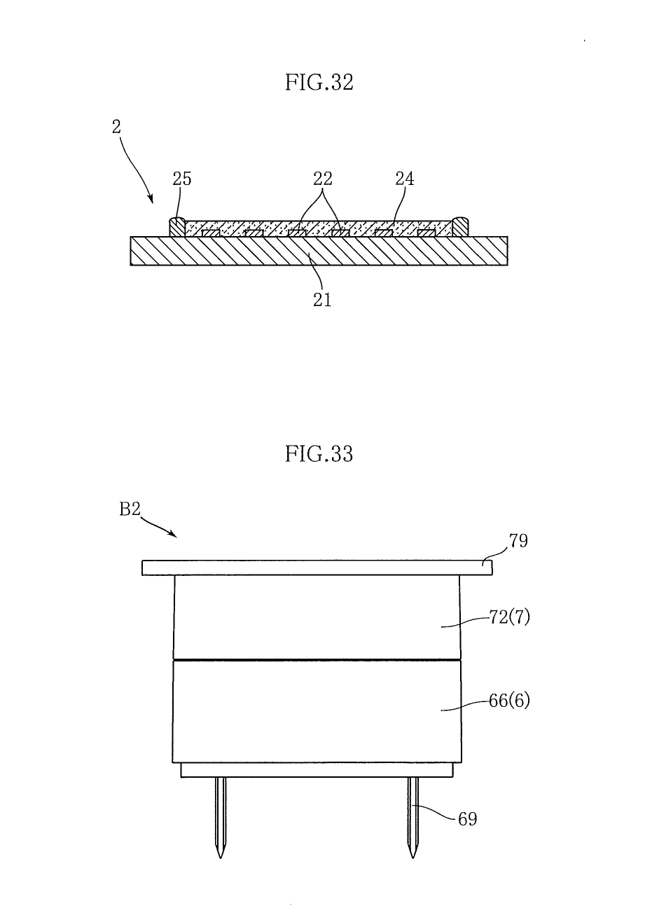

The LED light emission unit 2 is a light source part of the LED module A10. FIG. 32 is an enlarged cross-sectional view showing the LED light emission unit 2. As shown in the drawing, the LED light emission unit 2 in the present embodiment includes the LED substrate 21, the plurality of LED chips 22, the dam part 25, and the sealing resin 24.

The LED substrate 21 supports the plurality of LED chips 22, and has conduction paths to them. Although the specific configuration of the LED substrate 21 is not particularly limited, the LED substrate 21 is made up of, for example, a base member and a wiring pattern. The base member is made of insulating material, and is made of glass epoxy resin or ceramic with enhanced thermal conductivity. The wiring pattern is mounted with the plurality of LED chips 22, and constitutes conduction paths to these LED chips 22. The wiring pattern is made of a metal-plated layer, and is made of Cu, Ni, Au, or Ag, for example.

The plurality of LED chips 22 are light emission elements of the LED light emission unit 2. The LED chips 22 have a semiconductor layer made of GaN for example, and emit blue light for example. In the present embodiment, the plurality of LED chips 22 are mounted on the LED substrate 21 substantially in a matrix. The LED chips 22 are LED chips of the so-called two-wire type. However, they may be LED chips of the so-called one-wire type, or LED chips of the flip chip type.

The dam part 25 is formed on the LED substrate 21, and surrounds the plurality of LED chips 22. In the present embodiment, the dam part 25 has a rectangular ring shape in plan view, and is made of white silicone resin or epoxy resin, for example. The height of the dam part 25 is greater than the height of the LED chips 22.

The sealing resin 24 covers the plurality of LED chips 22, and fills the region that is surrounded by the dam part 25. The sealing resin 24 is made of, for example, transparent resin such as silicone resin or epoxy resin, into which a fluorescent substance is mixed. This fluorescent substance emits yellow light due to excitation by blue light from the LED chips 22. Alternatively, a mixture of a fluorescent substance that emits red light and a fluorescent substance that emits green light, due to excitation by blue light from the LED chips 22, may be used. With this configuration, the LED light emission unit 2 emits light of a white color such as a warm white color or a daylight color.

The LED light emission unit 2 is attached to the heat dissipation member 4, and the heat dissipation member 4 has the function of facilitating dissipation of heat from the LED light emission unit 2 during lighting. The heat dissipation member 4 has a top panel part 41, a cylindrical part 42, a plurality of fins 43, and a pair of supporting parts 44.

The top panel part 41 is a flat plate-shaped part that is orthogonal to the opening direction of the device casing 6. In the present embodiment, the top panel part 41 has a substantially rectangular shape in plan view. The LED light emission unit 2 is attached to a supporting surface 411, which is the upper surface of the top panel part 41 in the drawing. As shown in FIG. 24, the forward end of the short cylindrical part 652 of the ring-shaped flange part 65 of the device casing 6 in the emission direction is located backward in the emission direction from the supporting surface 411 of the heat dissipation member 4. In other words, the supporting surface 411 is located forward in the emission direction from the forward end of the short cylindrical part 652 in the emission direction. Also, the supporting surface 411 is located forward in the emission direction from the thin-wall cylindrical part 722 of the cylindrical part 72 of the external covering 7.

The cylindrical part 42 is a cylindrical part that extends backward from the top panel part 41 in the emission direction, which is the opposite direction to the side on which the LED light emission unit 2 is attached. In the present embodiment, the cylindrical part 42 has a substantially rectangular cylinder shape. Also, the plurality of fins 43 are formed on the cylindrical part 42. The plurality of fins 43 extend outward from the cylindrical part 42. The plurality of fins 43 each extend along the opening direction, and are arranged to be parallel to each other. The plurality of fins 43 are housed within the cup-shaped part 62 of the device casing 6.

The pair of supporting parts 44 are each located between the supporting surface 411 and the plurality of fins 43 in the emission direction. The supporting parts 44 extend outward in the radial direction. The pair of supporting parts 44 extend in the opposite directions in the radial direction.

The supporting parts 44 are supported by the forward end of the inner cylinder part 63 in the emission direction. In the present embodiment, the supporting parts 44 are in direct contact with the forward end of the inner cylinder part 63 in the emission direction, and are fixed with a screw 441. The forward end surfaces of the supporting parts 44 in the emission direction are located backward in the emission direction from the supporting surface 411. Also, the forward end surfaces of the supporting parts 44 in the emission direction are located backward in the emission direction from the forward end of the short cylindrical part 652 in the emission direction.

The covering 3 is attached to the heat dissipation member 4, and allows light from the LED light emission unit 2 to pass through. Also, in the present embodiment, the covering 3 allows light from the LED light emission unit 2 to pass through and diffuse, and is made of semitransparent milky white material, for example. Such a covering 3 is made of resin or glass.

As shown in FIG. 30 and FIG. 31, the covering 3 has the inner surface 310, the outer surface 320, and an outer recessed surface 328.

The inner surface 310 is a flat surface that directly faces the LED light emission unit 2 and receives light from the LED light emission unit 2. In the present embodiment, the inner surface 310 is a rough surface.

The outer surface 320 is a curved surface that is located on the opposite side to the inner surface 310 (on the upper side in the drawing), and that bulges outward. The outer surface 320 is as rough as the inner surface 310. Note that a configuration may be adopted in which the outer surface 320 is a smooth surface unlike in the present embodiment.

The outer recessed surface 328 is recessed from the outer surface 320. In the present embodiment, the outer recessed surface 328 has a cone shape. Also, as shown in FIG. 30, the outer recessed surface 328 is located to overlap the LED light emission unit 2 in plan view. Furthermore, in the present embodiment, the center of the outer recessed surface 328 in plan view coincides with the center of the LED light emission unit 2 in plan view. The outer recessed surface 328 is a smooth surface that is smooth relative to the inner surface 310 and the outer surface 320.

The power supply unit 5 is, for example, for converting commercial 100 V AC power to DC power that is suited to light the plurality of LED chips 22 of the LED light emission unit 2. The power supply unit 5 is housed within the cylindrical part 42 of the heat dissipation member 4.

The power supply unit 5 in the present embodiment is made up of the power supply substrate 51 and the plurality of electronic parts 52.

The power supply substrate 51 serves as a foundation for the power supply unit 5, and supports the plurality of electronic parts 52. The power supply substrate 51 also has conduction paths for electrically connecting the plurality of electronic parts 52 with each other as needed. In the present embodiment, as shown in FIG. 30, the power supply substrate 51 is arranged so as to be shifted to the forward side of the cylindrical part 42 in the emission direction (toward the top panel part 41).

The plurality of electronic parts 52 are elements that constitute a power supply circuit for realizing the functions of the power supply unit 5. Although the types and the specifications of the plurality of electronic parts are not particularly limited, their representative examples include a transformer, a capacitor, a resistor, and a diode.

As shown in FIG. 30 and FIG. 31, the LED cable 58 and the power supply cable 59 are connected to the power supply unit 5. The LED cable 58 is for supplying power from the power supply unit 5 to the LED light emission unit 2, and is connected to the power supply unit 5 and the LED light emission unit 2. The power supply cable 59 is for conducting power received from the outside to the power supply unit 5.

Next, a description is given of the effect of the LED illumination device B1.

According to the present embodiment, the supporting parts 44, which are located between the supporting surface 411 and the fins 43 in the emission direction, are attached to the device casing 6. The LED light emission unit 2 is supported on the supporting surface 411. When the LED light emission unit 2 emits light, heat from the LED light emission unit 2 travels from the supporting surface 411 toward the fins 43, and is also conducted from the supporting parts 44, which are nearer to the supporting surface 411 than the fins 43 are, to the device casing 6. As a result, a greater amount of heat can be dissipated, not only from the fins 43, but also from the supporting parts 44 via the device casing 6. Therefore, it is possible to facilitate dissipation of heat from the LED light emission unit 2. By suppressing a rise in temperature during light emission by the LED light emission unit 2, it is possible to prevent a decrease in the light emission efficiency of the LED chips 22. Also, it is possible to prevent the LED chips 22 from having a short lifespan.

The supporting parts 44 extend outward in the radial direction. With this configuration, it is possible to easily attach the supporting parts 44 to the device casing 6.

Since the heat dissipation member 4 has the pair of supporting parts 44 that extend in the opposite directions in the radial direction, the heat dissipation member 4 can be more stably fixed to the device casing 6.

Since the heat dissipation member 4 has the top panel part 41, the supporting surface 411 has a relatively large area. Due to the cylindrical part 42 located backward from the top panel part 41 in the emission direction, the power supply unit 5 and so on can be housed properly. Since the cylindrical part 42 is provided with the plurality of fins 43, it is possible to facilitate the heat dissipation effect due to the surface area being enlarged by the plurality of fins 43.

The device casing 6 is configured from the outer cylinder part 61 and the cup-shaped part 62, and the outer cylinder part 61 has a cylindrical shape elongated in the emission direction. With this configuration, the LED illumination device B1 can be installed in the upright position at a higher level from the ground. Meanwhile, the cup-shaped part 62 can be configured to have a shape that is suited to hold the LED module A10.

Since the pair of supporting parts 44 of the heat dissipation member 4 are attached to the forward end of the inner cylinder part 63 of the device casing 6 in the emission direction, heat can be properly conducted from the supporting parts 44 to the inner cylinder part 63. Also, the ring-shaped flange part 65 is connected to a forward portion of the inner cylinder part 63 in the emission direction. Therefore, heat can be readily conducted from the supporting parts 44 to the ring-shaped flange part 65 via the inner cylinder part 63. The supporting parts 44 in direct contact with the inner cylinder part 63 are suited to improve the efficiency of heat conduction from the supporting parts 44 to the inner cylinder part 63. Fixing using the screw 441 has an advantage that the supporting parts 44 can be reliably and firmly attached to the inner cylinder part 63.

The ring-shaped flange part 65 has the ring-shaped disc part 651 and the short cylindrical part 652. Heat conducted from the inner cylinder part 63 to the ring-shaped disc part 651 is conducted to the short cylindrical part 652. The short cylindrical part 652 is located near the forward end of the outer cylinder part 61 in the emission direction. Therefore, heat is readily conducted to the outer cylinder part 61. Also, the short cylindrical part 652 is exposed from between the outer cylinder part 61 and the outer surface of the external covering 7. Therefore, heat can be dissipated from the short cylindrical part 652 to the outside.

Since the supporting surface 411 is located forward in the emission direction from the forward end of the short cylindrical part 652 in the emission direction, the LED light emission unit 2, which is the light source, can be located more forward in the emission direction, which results in being able to illuminate a larger area. Since the forward end surfaces of the supporting parts 44 in the emission direction are located backward from the supporting surface 411 in the emission direction, the supporting parts and the screw 441 are prevented from inappropriately blocking light from the LED light emission unit 2.

Since the inner cylinder part 63 has a larger wall thickness than the outer cylinder part 61, heat generated from the LED light emission unit 2 when lighting starts or the like can be readily absorbed by the inner cylinder part 63 that has not reached a high temperature.

Since the covering 3 has the inner surface 310, a greater amount of light from the LED light emission unit 2, which the inner surface 310 directly faces, can enter the inner surface 310. Since the outer surface 320 bulges out in the opening direction, light that has entered from the inner surface 310 can be emitted while being deflected, which results in being able to illuminate a larger area.

The outer recessed surface 328 of the covering 3 has the function of reflecting light with a relatively high luminance, which has traveled from the central portion of the LED light emission unit 2 to the front side, toward the sides. Therefore, it is possible to prevent light with an excessively high luminance, which travels from the central portion of the LED light emission unit 2 to the front side, from directly reaching the light-shielding covering 79, which is a shielding object.

Since the inner surface 310 and the outer surface 320 are rough surfaces, light can be more widely diffused when entering the inner surface 310 and when emitted from the outer surface 320. This configuration is suited to illuminate a larger range. Since the outer recessed surface 328 is a smooth surface, light travelling from the central portion of the LED light emission unit 2 to the front side can be effectively reflected by so-called total reflection.

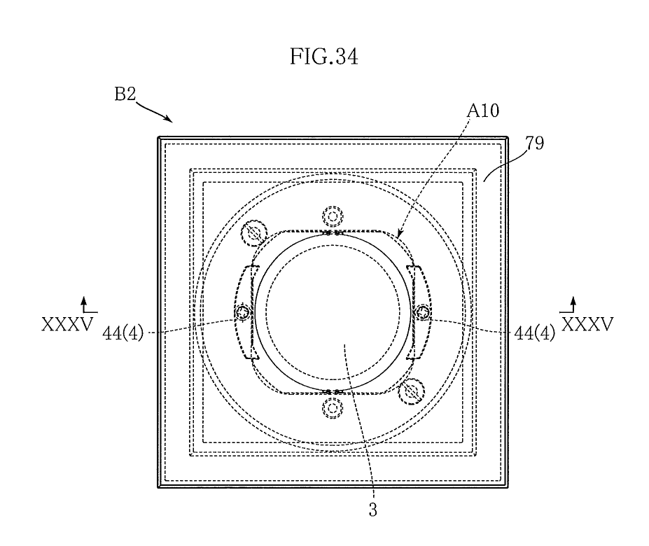

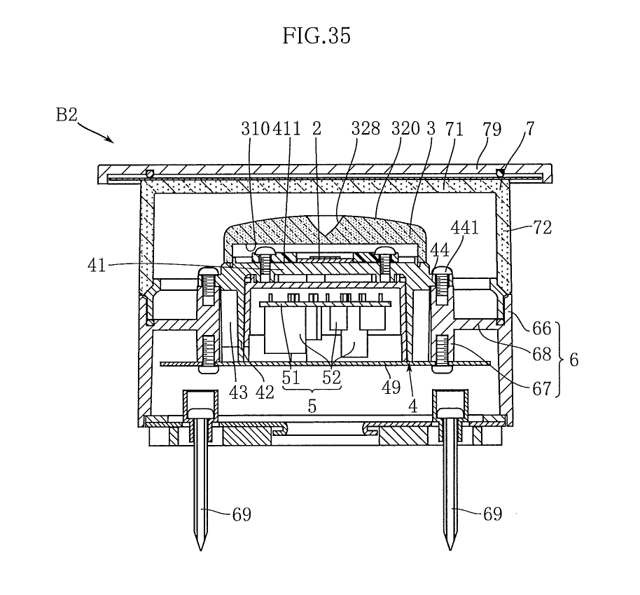

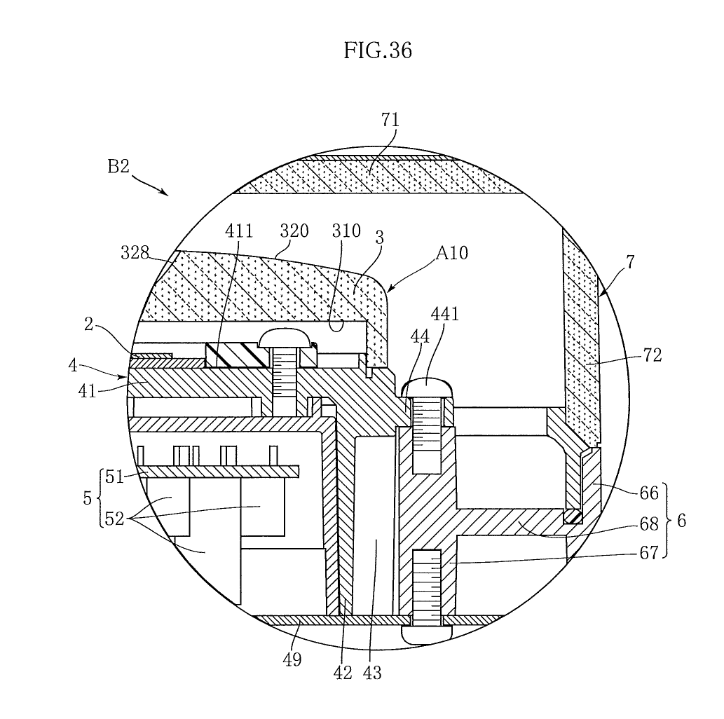

FIG. 33 to FIG. 36 show another example of an LED illumination device according to the present invention. Note that in these figures, the same reference signs are given to elements that are the same as or similar to the elements in the above-described embodiment. FIG. 33 is a front view showing an LED illumination device B2. FIG. 34 is a plan view showing the LED illumination device B2. FIG. 35 is a cross-sectional view along a line XXXV-XXXV in FIG. 34. FIG. 36 is an enlarged cross-sectional view showing a main portion of the LED illumination device in FIG. 33.

The LED illumination device B2 includes the LED module A10, the device casing 6, the external covering 7, and the light-shielding covering 79. The LED module A10 has the same configuration as the LED module A10 in the LED illumination device B1.

The device casing 6 in the present embodiment includes an outer cylinder part 66, an inner cylinder part 67, and a connector part 68.

As shown in FIG. 35 and FIG. 36, the outer cylinder part 66 and the inner cylinder part 67 are cylindrical parts that have the same central axis, and, in the present embodiment, the outer cylinder part 66 has a rectangular cylinder shape, and the inner cylinder part 67 has a circular cylinder shape. The outer cylinder part 66 and the inner cylinder part 67 are arranged with a gap between them. Also, the backward end of the outer cylinder part 66 in the emission direction is located backward in the emission direction from the backward end of the inner cylinder part 67 in the emission direction. The forward end of the outer cylinder part 66 in the emission direction is located backward in the emission direction from the forward end of the inner cylinder part 67 in the emission direction.

The connector part 68 connects the outer cylinder part 66 and the inner cylinder part 67. The connector part 68 is a plate-shaped part that has a rectangular ring shape in plan view (a view in the axial direction). The connector part 68 is connected to a substantially central portion of the inner cylinder part 67 in the emission direction. The connector part 68 is also connected to a forward portion of the outer cylinder part 66 in the emission direction.

The device casing 6 is made of, for example, metal such as aluminum. Also, the inner cylinder part 67 has a wall thickness that is greater than that of the outer cylinder part 66.

A plurality of attaching screws 69 are provided for the device casing 6. The plurality of attaching screws 69 are used for attaching the LED illumination device B2 to an installation surface.

The supporting parts 44 of the heat dissipation member 4 are supported by the forward end of the inner cylinder part 67 in the emission direction. More specifically, the supporting parts 44 of the heat dissipation member 4 are in direct contact with the forward end of the inner cylinder part 67 in the emission direction, and are fixed with the screw 441. The forward end of the outer cylinder part 66 in the emission direction is located backward in the emission direction from the supporting surface 411.

The plurality of fins 43 of the heat dissipation member 4 are housed within the inner cylinder part 67 of the device casing 6. With respect to the emission direction, the positions of the respective backward ends in the emission direction of the cylindrical part 42 and the fins 43 of the heat dissipation member 4 substantially coincide with the position of the backward end in the emission direction of the inner cylinder part 67 of the device casing 6. A heat sink plate 49 is in contact with the backward ends of the cylindrical part 42 and the fins 43 of the heat dissipation member 4 in the emission direction and with the backward end of the inner cylinder part 67 of the device casing 6 in the emission direction. The heat sink plate 49 is for facilitating dissipation of heat from the LED light emission unit 2. In the example shown in the drawing, the heat sink plate 49 is fixed to the backward end of the inner cylinder part 67 of the device casing 6 in the emission direction with a bolt.

The external covering 7 has the top panel part 71 and the cylindrical part 72. In the present embodiment, the cylindrical part 72 has a rectangular cylinder shape. As shown in FIG. 35 and FIG. 36, the backward end of the cylindrical part 72 in the emission direction is adjacent to the forward end of the outer cylinder part 66 of the device casing 6 in the emission direction. The material and so on of the external covering 7 is the same as the external covering 7 in the LED illumination device B1.

The light-shielding covering 79 is attached to the forward end of the external covering 7 in the emission direction, and covers the external covering 7 from the forward side in the emission direction. The light-shielding covering 79 in the present embodiment has a rectangular shape in plan view (a view in the axial direction), and its external dimensions are greater than the external dimensions of the device casing 6. The light-shielding covering 79 is made of opaque material, and blocks light from the LED module A10.

With such an embodiment, it is possible to facilitate dissipation of heat from the LED light emission unit 2. Also, in plan view (a view in the emission direction), the inner cylinder part 67 has a circular shape and the outer cylinder part 66 has a rectangular shape, and the connector part 68 is provided to fill the gap between them in plan view. With this configuration, heat conducted from the supporting parts 44 fixed to the inner cylinder part 67 is readily conducted to the outer cylinder part 66 via the connector part 68. Also, the outer cylinder part 66 is a part that is exposed to the outside. Therefore, it is preferable for dissipation of heat from the LED light emission unit 2.

The supporting surface 411 is located forward in the emission direction from the forward end of the outer cylinder part 66 of the device casing 6 in the emission direction. With this configuration, it is possible to allow light from the LED light emission unit 2 to reach a larger area. Since the forward end surfaces of the supporting parts 44 in the emission direction are located backward from the supporting surface 411 in the emission direction, the supporting parts 44 and the screw 441 are prevented from inappropriately blocking light from the LED light emission unit 2.

Since the heat sink plate 49 is provided, dissipation of heat from the LED light emission unit 2 can be more reliably facilitated. The heat sink plate 49 is in contact with both: the fins 43 and the cylindrical part 42 of the heat dissipation member 4; and the inner cylinder part 67 of the device casing 6. With this configuration, heat can be conducted from both the heat dissipation member 4 and the device casing 6 to the heat sink plate 49.

The backward end of the cylindrical part 72 of the external covering 7 in the emission direction is located backward in the emission direction from the supporting surface 411. With this configuration, a larger area can be illuminated with light from the LED module A10 (LED light emission unit 2).

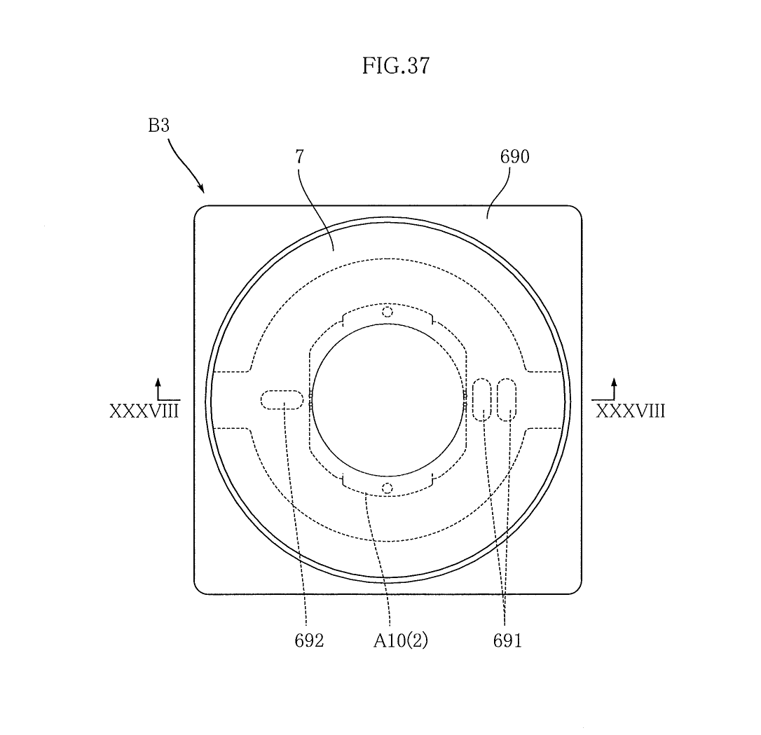

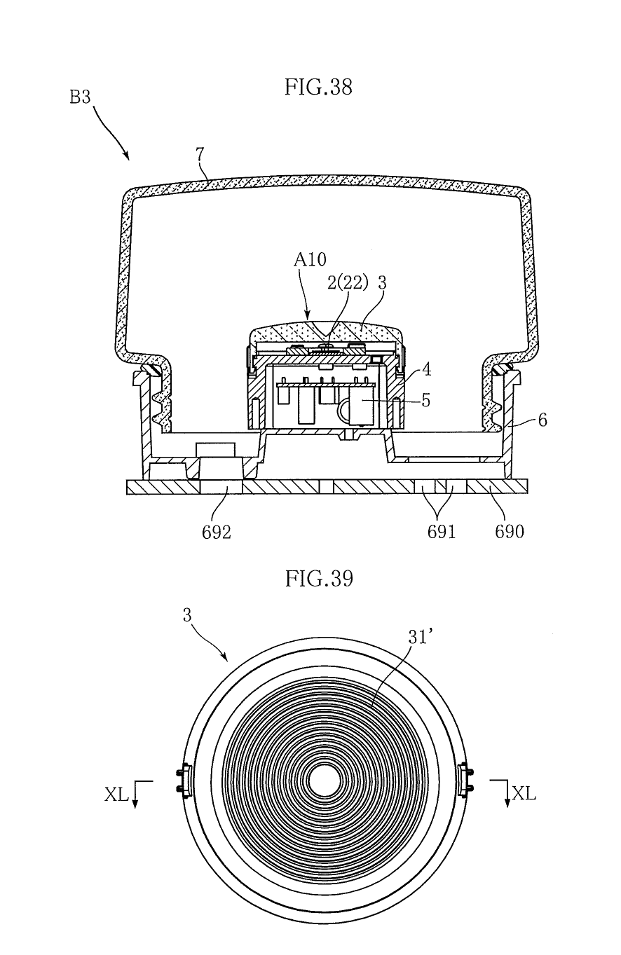

FIG. 37 and FIG. 38 show yet another example of an LED illumination device according to the present invention. An LED illumination device B3 in the present embodiment includes the LED module A10, the device casing 6, and the external covering 7. The LED illumination device B3 is used as a so-called bracket light, which is a kind of light fixture that is to be attached to a ceiling or a wall, for example.

The device casing 6 has a cylindrical shape with a bottom. In the present embodiment, the device casing 6 has a circular shape in plan view. The device casing 6 is made of, for example, metal such as aluminum. Also, the device casing 6 in the present embodiment is supported by a base 690. The base 690 is a plate-shaped member that is made of metal or resin for example, and is used as a foundation for attaching the LED illumination device B3 to a ceiling or a wall.

Two attaching holes 691 and one attaching hole 692 are formed in the base 690. The two attaching holes 691 and the one attaching hole 692 are arranged on the opposite sides of the LED module A10 in plan view. The positions of the two attaching holes 691 coincide in the circumferential direction, and are separated from each other in the radial direction. The attaching holes 691 are elongated holes whose longitudinal directions coincide with the circumferential direction (the vertical direction in FIG. 37). The attaching hole 692 is an elongated hole whose longitudinal direction coincides with the radial direction (the horizontal direction in the drawing).

When installing the LED illumination device B3, it is common to use two attaching bolts. The pitch of the two attaching bolts is determined according to the custom, the industrial standard, etc. When installing the LED illumination device B3, it can be conceived that the two attaching bolts are adapted to two different pitches depending on the type and the size of the LED illumination device B3 as an illumination device. By using the attaching hole 691 shown on the right side in the drawing and the attaching hole 692, it is possible to address the case in which the two attaching bolts are used with a relatively long pitch. On the other hand, by using the attaching hole 691 shown on the left side in the drawing and the attaching hole 692, it is possible to address the case in which the two attaching bolts are used with a relatively short pitch.

As shown in FIG. 26, FIG. 27, and FIG. 37, the pair of supporting parts 44 are retreated in the region sandwiched between the two attaching holes 691 and the attaching hole 692. The heat dissipation member 4 of the LED module A10 has a substantially rectangular shape in plan view. As clearly shown in FIG. 37, the two sides of the LED module A10 (the heat dissipation member 4) that are parallel to the vertical direction in the drawing are arranged in the region sandwiched between the two attaching holes 691 and the attaching hole 692. With this configuration, it is possible to prevent the two attaching bolts described above and the LED module A10 from interfering with each other.

FIG. 39 and FIG. 40 show a modification of the covering 3. In this modification, the covering 3 has a Fresnel lens surface 41′ and the outer surface 320. The Fresnel lens surface 41′ is a surface that directly faces the LED light emission unit 2, and receives light from the LED light emission unit 2. The Fresnel lens surface 41′ is a surface in which a plurality of protrusions and recesses, each having a circular ring shape, are arranged concentrically with a predetermined pitch. With such a modification, the travelling direction of light from the LED light emission unit 2 can be spread toward the sides by the Fresnel lens surface 41′.

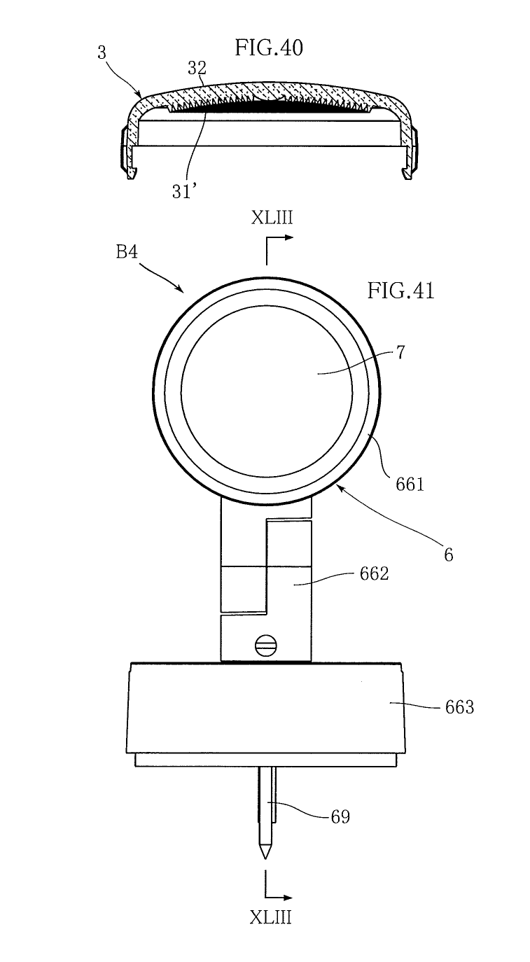

FIG. 41 to FIG. 43 show yet another example of an LED illumination device according to the present invention. An LED illumination device B4 in the present embodiment is configured as an LED illumination device of the so-called spot light type. The LED illumination device B4 includes the LED module A10, the device casing 6, and the external covering 7, and is attached to an installation surface with the attaching screws 69.

The device casing 6 in the present embodiment is made up of a cylindrical part 661, a joint part 662, and a foundation part 663. The cylindrical part 661 is a cylindrical part with a bottom, whose axial direction coincides with the emission direction of the LED module A10, and houses the LED module A10. Also, in the present embodiment, the external covering 7 having a disc shape is provided so as to close the cylindrical part 661. The external covering 7 may be made of transparent material.

The foundation part 663 is a part that is to be attached to the installation surface with the attaching screws 69. The foundation part 663 has a circular shape in plan view, for example.

The joint part 662 is a part for connecting the cylindrical part 661 and the foundation part 663, and for positioning the cylindrical part 661 to face in a desired direction with respect to the foundation part 663. The joint part 662 is made up of two portions connected with a hinge mechanism.

With such an embodiment, it is possible to facilitate dissipation of heat from the LED light emission unit 2.

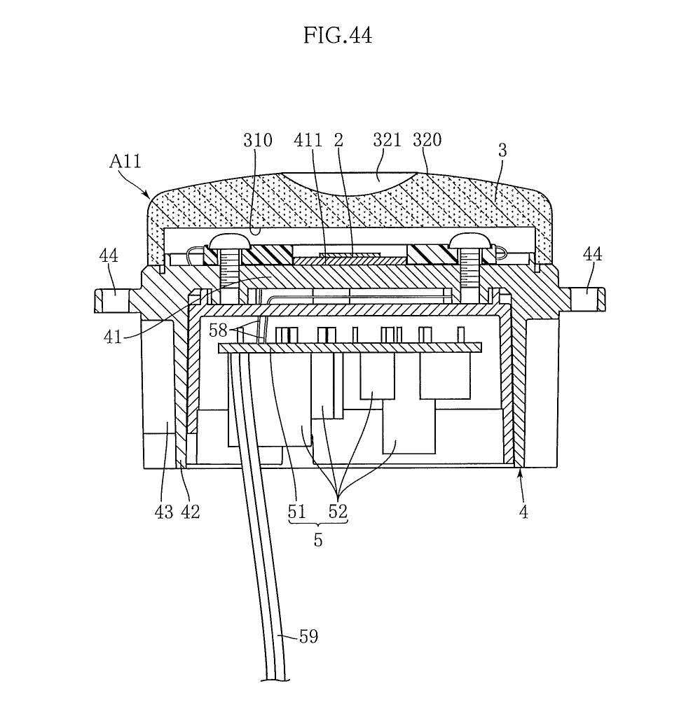

FIG. 44 shows another example of an LED module. In an LED illumination module A11 in the present embodiment, the inner surface 310 of the covering 3 is a smooth flat surface. Also, the outer recessed surface 321 is formed in the outer surface 320. The outer recessed surface 321 is a curved surface that is moderately recessed.

With such an embodiment, it is possible to facilitate dissipation of heat from the LED light emission unit 2. Also, as with the above-described LED illumination module A1, the LED illumination module A11 is able to realize preferable light emission and suppress the glare.

An LED illumination module according to the present invention is not limited to the above-described embodiments. Various design changes can be made to the specific configurations of the constituent parts of an LED illumination module according to the present invention.

Technical configurations of an LED illumination module and an LED illumination device provided by the present invention are enumerated below as appendixes.

### APPENDIX 1A

An LED illumination module comprising: an LED light emission unit having at least one LED chip; and

a covering that allows light from the LED light emission unit to pass through,

wherein the covering has an inner surface that is located on the LED light emission unit's side and an outer surface that is located on an opposite side to the inner surface, and

the inner surface has an inner recessed surface that is recessed in a direction away from the LED light emission unit.

### APPENDIX 2A

The LED illumination module according to claim 1A, wherein the inner recessed surface is a smooth mirror-finished surface.

### APPENDIX 3A

The LED illumination module according to claim 1A or 2A, wherein the inner recessed surface directly faces the LED light emission unit.

### APPENDIX 4A

The LED illumination module according to any one of claims 1A to 3A, wherein the inner recessed surface has a circular shape in plan view.

### APPENDIX 5A

The LED illumination module according to any one of claims 1A to 4A, wherein the inner surface has an inner ring-shaped surface that surrounds the inner recessed surface.

### APPENDIX 6A

The LED illumination module according to claim 5A, wherein the inner ring-shaped surface is a smooth mirror-finished surface.

### APPENDIX 7A

The LED illumination module according to claim 5A or 6A, wherein the inner ring-shaped surface is a flat surface.

### APPENDIX 8A

The LED illumination module according to any one of claims 5A to 7A, wherein the inner ring-shaped surface has a circular ring shape in plan view.

### APPENDIX 9A

The LED illumination module according to any one of claims 1A to 8A, wherein the inner surface has a circular shape in plan view.

### APPENDIX 10A

The LED illumination module according to any one of claims 1A to 9A, wherein the outer surface is an entirely uneven surface.

### APPENDIX 11A

The LED illumination module according to any one of claims 1A to 10A, wherein the outer surface as a whole has a shape that bulges in a direction away from the LED light emission unit.

### APPENDIX 12A

The LED illumination module according to claim 11A, wherein a radius of curvature of the outer surface is greater than a radius of curvature of the inner recessed surface.

### APPENDIX 13A

The LED illumination module according to any one of claims 1A to 10A, wherein the outer surface is a flat surface.

### APPENDIX 14A

The LED illumination module according to any one of claims 1A to 9A, wherein the outer surface overlaps the inner recessed surface in plan view, and has an outer recessed surface that is recessed in a direction toward the LED light emission unit.

### APPENDIX 15A

The LED illumination module according to claim 14A, wherein the outer recessed surface is a smooth mirror-finished surface.

### APPENDIX 16A

The LED illumination module according to claim 14A or 15A, wherein a lens center point of the outer recessed surface and a lens center point of the inner recessed surface coincide with each other in plan view.

### APPENDIX 17A

The LED illumination module according to any one of claims 14A to 16A, wherein a radius of curvature of the outer recessed surface is greater than a radius of curvature of the inner recessed surface.

### APPENDIX 18A

The LED illumination module according to claim 17A, wherein the outer recessed surface is greater than the inner recessed surface in plan view.

### APPENDIX 19A

The LED illumination module according to any one of claims 14A to 18A, wherein the outer surface has an outer ring-shaped surface that surrounds the outer recessed surface.

### APPENDIX 20A

The LED illumination module according to claim 19A, wherein the outer ring-shaped surface is an uneven surface.

### APPENDIX 21A

The LED illumination module according to claim 19A or 20A, wherein the outer ring-shaped surface has a shape that bulges in a direction away from the LED light emission unit.

### APPENDIX 22A

The LED illumination module according to claim 19A or 20A, wherein the outer ring-shaped surface is a flat surface.

### APPENDIX 23A

The LED illumination module according to any one of claims 1A to 22A, wherein the outer surface has a circular shape in plan view.

### APPENDIX 24A

The LED illumination module according to any one of claims 1A to 23A, wherein the covering allows light from the LED light emission unit to pass through and diffuse.

### APPENDIX 25A

The LED illumination module according to claim 24A, wherein the covering is made of milky white material.

### APPENDIX 26A

The LED illumination module according to any one of claims 1A to 25A, comprising:

a casing that supports the LED light emission unit; and

a base that is provided on an opposite side to the LED light emission unit, and that is capable of being attached to and detached from a power feeding unit,

wherein attaching and detaching of the base and the power feeding unit include an operation of rotating the base relative to the power feeding unit.

### APPENDIX 27A

The LED illumination module according to claim 26A, wherein the base includes a pair of pins.

### APPENDIX 28A

The LED illumination module according to any one of claims 1A to 27A, wherein the LED light emission unit includes: an LED substrate; a plurality of LED chips mounted on the LED substrate; and a sealing resin that covers the LED chips.

### APPENDIX 29A

The LED illumination module according to claim 28A, wherein the LED substrate has a base member that is made of ceramic.

### APPENDIX 30A

The LED illumination module according to claim 28A or 29A,

wherein fluorescent material that emits, due to excitation by light from the LED chips, light having a color that is different from a color of light from the LED chips, is mixed into the sealing resin, and the LED light emission unit emits white light.

### APPENDIX 31A

The LED illumination module according to any one of claims 28A to 30A, wherein

the plurality of LED chips are of a two-wire type, and

adjacent LED chips out of the LED chips are directly connected with a wire.

### APPENDIX 32A

The LED illumination module according to claim 31A, wherein all of the plurality of LED chips are connected in series.

### APPENDIX 33A

The LED illumination module according to claim 26A, wherein the casing has a heat dissipation member that is made of metal.

### APPENDIX 34A

The LED illumination module according to claim 33A, wherein a plurality of fins are formed on the casing.

### APPENDIX 1B

An LED illumination device comprising an LED light emission unit that includes an LED chip, the LED illumination device further comprising:

an LED module that includes the LED light emission unit and a heat dissipation member that supports the LED light emission unit;

a device casing that supports the LED module; and

an external covering that allows light from the LED module to pass through,

wherein the heat dissipation member has a supporting surface that supports the LED light emission unit; a plurality of fins that are located backward from the supporting surface in an emission direction of the LED light emission unit; and a supporting part that is located between the supporting surface and the fins in the emission direction, and

the supporting part is attached to the device casing.

### APPENDIX 2B

The LED illumination device according to Appendix 1B, wherein the supporting part extends outward in a radial direction.

### APPENDIX 3B

The LED illumination device according to Appendix 2B, wherein the heat dissipation member has the supporting part that is provided in a pair, and the pair of supporting parts extend in opposite directions in the radial direction.

### APPENDIX 4B

The LED illumination device according to Appendix 2B or 3B, wherein the heat dissipation member has: a top panel part whose forward surface in the emission direction serves as the supporting surface; and a cylindrical part whose forward portion in the emission direction is closed by the top panel part.

### APPENDIX 5B

The LED illumination device according to Appendix 4B, wherein the plurality of fins are formed on an outer surface of the cylindrical part.

### APPENDIX 6B

The LED illumination device according to Appendix 5B, wherein the device casing includes an outer cylinder part and a cup-shaped part.

### APPENDIX 7B

The LED illumination device according to Appendix 6B, wherein the cup-shaped part has: an inner cylinder part; a bottom part that closes a backward portion of the inner cylinder part in the emission direction; and a ring-shaped flange part that extends outward in the radial direction from a forward portion of the inner cylinder part in the emission direction.

### APPENDIX 8B

The LED illumination device according to Appendix 7B, wherein the supporting part of the heat dissipation member is supported by a forward end of the inner cylinder part in the emission direction.

### APPENDIX 9B

The LED illumination device according to Appendix 8B, wherein the supporting part of the heat dissipation member is in direct contact with the forward end of the inner cylinder part in the emission direction, and is fixed with a screw.

### APPENDIX 10B

The LED illumination device according to Appendix 8B or 9B, wherein the plurality of fins of the heat dissipation member are housed in the cup-shaped part of the device casing.

### APPENDIX 11B

The LED illumination device according to any one of Appendixes 8B to 10B, wherein the ring-shaped flange part is located forward in the emission direction from a forward end of the outer cylinder part in the emission direction.

### APPENDIX 12B

The LED illumination device according to Appendix 11B, wherein the ring-shaped flange part is in direct contact with the forward end of the outer cylinder part in the emission direction.

### APPENDIX 13B

The LED illumination device according to Appendix 11B or 12B, wherein the ring-shaped flange part is exposed outward in the radial direction from between the outer surface of the external covering and the forward end of the outer cylinder part in the emission direction.

### APPENDIX 14B

The LED illumination device according to Appendix 13B, wherein the ring-shaped flange part has: a ring-shaped disc part that is connected to the inner cylinder part and extends outward in the radial direction; and a short cylindrical part that is connected to a peripheral edge of the ring-shaped disc part and stands along the emission direction.

### APPENDIX 15B

The LED illumination device according to Appendix 14B, wherein a forward end of the short cylindrical part in the emission direction is located backward in the emission direction from the supporting surface of the heat dissipation member.

### APPENDIX 16B

The LED illumination device according to Appendix 15B, wherein the external covering has a thin-wall cylindrical part that is located inward in the radial direction from the short cylindrical part of the ring-shaped flange part.

### APPENDIX 17B

The LED illumination device according to Appendix 16B, wherein the inner cylinder part of the cup-shaped part has a wall thickness that is greater than a wall thickness of the outer cylinder part.

### APPENDIX 18B

The LED illumination device according to any one of Appendixes 6B to 17B, wherein the outer cylinder part is made of metal.

### APPENDIX 19B

The LED illumination device according to any one of Appendixes 6B to 18B, wherein the cup-shaped part is made of metal.

### APPENDIX 20B

The LED illumination device according to Appendix 5B, wherein the device casing includes an outer cylinder part, an inner cylinder part, and a connector part that connects the outer cylinder part and the outer cylinder part.

### APPENDIX 21B

The LED illumination device according to Appendix 20B, wherein the supporting part of the heat dissipation member is supported by a forward end of the inner cylinder part in the emission direction.

### APPENDIX 22B

The LED illumination device according to Appendix 21B, wherein the supporting part of the heat dissipation member is in direct contact with the forward end of the inner cylinder part in the emission direction, and is fixed with a screw.

### APPENDIX 23B

The LED illumination device according to Appendix 21B or 22B, wherein the plurality of fins of the heat dissipation member are housed in the inner cylinder part of the device casing.

### APPENDIX 24B

The LED illumination device according to any one of Appendixes 21B to 23B, wherein a forward end of the outer cylinder part in the emission direction is located backward in the emission direction from the supporting surface.

### APPENDIX 25B

The LED illumination device according to Appendix 24B, wherein a backward end of the external covering in the emission direction is adjacent to a forward end of the outer cylinder part of the device casing in the emission direction.

### APPENDIX 26B

The LED illumination device according to any one of Appendixes 20B to 25B, wherein the inner cylinder part has a wall thickness that is greater than a wall thickness of the outer cylinder part.

### APPENDIX 27B

The LED illumination device according to any one of Appendixes 20B to 26B, wherein the device casing is made of metal.

### APPENDIX 28B

The LED illumination device according to any one of Appendixes 20B to 27B, comprising a heat sink plate that is attached to a backward end of the heat dissipation member in the emission direction.

### APPENDIX 29B

The LED illumination device according to any one of Appendixes 1B to 28B, wherein the LED module has a power supply unit that supplies power to the LED light emission unit.

### APPENDIX 30B

The LED illumination device according to Appendix 29B, wherein the power supply unit is housed in the cylindrical part of the heat dissipation member.

### APPENDIX 31B

The LED illumination device according to any one of Appendixes 13B to 16B, wherein the LED module is attached to the heat dissipation member, and has a covering that allows light from the LED light emission unit to pass through.

### APPENDIX 32B

The LED illumination device according to Appendix 31B, wherein the covering allows light from the LED light emission unit to pass through and diffuse.

### APPENDIX 33B

The LED illumination device according to Appendix 32B, wherein the covering is made of resin or glass.

### APPENDIX 34B

The LED illumination device according to any one of Appendixes 31B to 33B, wherein the covering directly faces the LED light emission unit and has an inner surface that receives light from the LED light emission unit.

### APPENDIX 35B

The LED illumination device according to Appendix 34B, wherein the covering has an outer surface that is located on an opposite side to the inner surface and bulges outward.

### APPENDIX 36B

The LED illumination device according to Appendix 35B, wherein the covering has an outer recessed surface that is recessed from the outer surface.

### APPENDIX 37B

The LED illumination device according to Appendix 36B, wherein the outer recessed surface has a cone shape.

### APPENDIX 38B

The LED illumination device according to Appendix 37B, wherein the outer recessed surface is located to overlap the LED light emission unit in plan view.

### APPENDIX 39B

The LED illumination device according to Appendix 38B, wherein a center of the outer recessed surface in plan view coincides with a center of the LED light emission unit in plan view.

### APPENDIX 40B

The LED illumination device according to any one of Appendixes 37B to 39B, wherein the inner surface is a rough surface.

### APPENDIX 41B

The LED illumination device according to Appendix 40B, wherein the outer surface is a rough surface.

### APPENDIX 42B

The LED illumination device according to Appendix 41B, wherein the outer recessed surface is a smooth surface.

### APPENDIX 43B

The LED illumination device according to any one of Appendixes 1B to 42B, wherein the LED light emission unit has: the LED chip that is provided in a plurality; and an LED substrate on which the plurality of LED chips are mounted.

### APPENDIX 44B

The LED illumination device according to Appendix 43B, wherein the LED light emission unit is provided on the LED substrate, has a ring shape that surrounds the plurality of LED chips, and has a dam part that protrudes from a surface of the LED substrate.

### APPENDIX 45B

The LED illumination device according to Appendix 44B, wherein the dam part is made of silicone resin.

### APPENDIX 46B

The LED illumination device according to Appendix 44B or 45B, wherein the LED light emission unit has a sealing resin that fills a region surrounded by the dam part and that covers the plurality of LED chips.

### APPENDIX 47B

The LED illumination device according to Appendix 46B, wherein the sealing resin includes fluorescent substances that emit light having different wavelengths due to excitation by light from the plurality of LED chips.

### APPENDIX 48B

The LED illumination device according to any one of Appendixes 1B to 47B, wherein the external covering allows light from the LED light emission unit to pass through and diffuse.

### APPENDIX 49B

The LED illumination device according to Appendix 48B, wherein the external covering is made of resin or glass.

1. An LED illumination module comprising:
an LED light emission unit having at least one LED chip; and
a covering that allows light from the LED light emission unit to pass through,
wherein the covering has an inner surface that is located on a side of the LED light emission unit and an outer surface opposite to the inner surface, and
the covering has at least one of: an inner recessed surface formed in the inner surface so as to be recessed in a direction away from the LED light emission unit; and an outer recessed surface formed in the outer surface so as to be recessed in a direction toward the LED light emission unit.

2. The LED illumination module according to claim 1, wherein the inner recessed surface is a smooth mirror-finished surface.

3. The LED illumination module according to claim 1, wherein the inner recessed surface faces the LED light emission unit.

4. The LED illumination module according to claim 1, wherein the inner recessed surface has a circular shape in plan view.

5. The LED illumination module according to claim 1, wherein the inner surface has an inner ring-shaped surface that surrounds the inner recessed surface.

6. The LED illumination module according to claim 5, wherein the inner ring-shaped surface is a smooth mirror-finished surface.

7. The LED illumination module according to claim 5, wherein the inner ring-shaped surface is a flat surface.

8. The LED illumination module according to claim 5, wherein the inner ring-shaped surface has a circular ring shape in plan view.

9. The LED illumination module according to claim 1, wherein the inner surface has a circular shape in plan view.

10. The LED illumination module according to claim 1, wherein the outer surface is an entirely uneven surface.

11. The LED illumination module according to claim 1, wherein the outer surface as a whole has a shape that bulges in a direction away from the LED light emission unit.

12. The LED illumination module according to claim 11, wherein a radius of curvature of the outer surface is greater than a radius of curvature of the inner recessed surface.

13. The LED illumination module according to claim 1, wherein the outer surface is a flat surface.

14. The LED illumination module according to claim 1, wherein the outer recessed surface overlaps the inner recessed surface in plan view.

15. The LED illumination module according to claim 14, wherein the outer recessed surface is a smooth mirror-finished surface.

16. The LED illumination module according to claim 14, wherein a center point of the outer recessed surface and a center point of the inner recessed surface coincide with each other in plan view.

17. The LED illumination module according to claim 14, wherein a radius of curvature of the outer recessed surface is greater than a radius of curvature of the inner recessed surface.

18. The LED illumination module according to claim 17, wherein the outer recessed surface is greater than the inner recessed surface in plan view.

19. The LED illumination module according to claim 2, wherein the outer recessed surface has a cone shape.

20. The LED illumination module according to claim 1, wherein the outer surface has an outer ring-shaped surface that surrounds the outer recessed surface.

21. The LED illumination module according to claim 20, wherein the outer ring-shaped surface is an uneven surface.

22. The LED illumination module according to claim 20, wherein the outer ring-shaped surface is a smooth surface.

23. The LED illumination module according to claim 20, wherein the outer ring-shaped surface has a shape that bulges in a direction away from the LED light emission unit.

24. The LED illumination module according to claim 20, wherein the outer ring-shaped surface is a flat surface.

25. The LED illumination module according to claim 1, wherein the outer surface has a circular shape in plan view.

26. The LED illumination module according to claim 1, wherein the inner recessed surface is smaller than a light emission region of the LED light emission unit in plan view.

27. The LED illumination module according to claim 1, wherein the inner recessed surface is greater than a light emission region of the LED light emission unit in plan view.

28. The LED illumination module according to claim 1, wherein the LED light emission unit has the LED chip that is provided in a plurality, the plurality of LED chips being arranged discretely in plan view, and
the covering has the inner recessed surface that is provided in a plurality, the plurality of inner recessed surfaces respectively overlapping the plurality of LED chips.
